(19) United States
(12) Patent Application Publication
(10) Pub. No.: US 2007/0073768 A1
(43) Pub. Date: Mar. 29, 2007

(54) INTERACTIVE SYSTEM FOR BUILDING AND SHARING ONE'S OWN DATABANK OF WISDOM BYTES, SUCH AS WORDS OF WISDOM, BASIC TRUTHS AND/OR FACTS AND AND FEATS, IN ONE OR MORE LANGUAGES

(76) Inventor: Gautam Dharamdas Goradia, Mumbai (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/575,398

(22) PCT Filed: Oct. 15, 2003
(86) PCT No.: PCT/IN03/00334

§ 371 Date: Apr. 6, 2006

(51) Int. Cl. G06F 17/00

(52) U.S. Cl. 707/104.1

(57) ABSTRACT

Interactive system for building and sharing one's own databank of wisdom bytes, such as words of wisdom, basic truths and/or facts and feats, in one or more languages, it being accepted that one may want to build such data based on one's personal interest, by well-defined classifications, that uses a computer system comprising of; a One or more database to store data user wise; b. A well classified (i) User Database; (ii) At least one data input, organizing & management module(s) allowing a user to input, append and/or Modify data, with or without Voice; (iii) Module allowing a user to invoke a Wisdom Bytes Session; (iv) Module allowing a user to Schedule such Wisdom Bytes on the user's computer, including hand held devices, at predefined and/or periodic intervals, with or without Voice; (v) Module allowing the User to Export data from the database; (vi) Module allowing the user to Import data built by another user using the same System; (vii) Module allowing the user to Translate data into one or more languages; (viii) Reports Module.

### FIELD OF INVENTION

The present invention relates to an interactive System for building (including saving, appending, retrieving, modifying) and sharing one's own databank of WISDOM BYTES, such as Words of Wisdom like adages, aphorisms, apothegms, axioms, catchwords, dictums, epigrams, epithets, expressions, gospels, home truths, idioms, mantras, maxims, mottos, phrases, proverbs, quotations, sayings, slogans and such others, Basic Truths, and/or Facts and Feats, in one or more languages, for increasing and improving one's own knowledge of such data, it being accepted that such data is used in daily life, in conversation, education and social life.

It is a well-accepted fact that over the years, holy books, fables, sages and saints, great leaders and revolutionaries, poets and writers, artists and entertainers, builders and titans, scientists and thinkers, heroes, have made statements, announcements, proclamations, etc. that have also been accepted as Words of Wisdom and Basic Truths, and people use such Words of Wisdom and Basic Truths as a part of their daily conversation, such Words of Wisdom and Basic Truths also being used extensively during the grooming years of a person while being educated at schools, colleges, universities, and that such Words of Wisdom and Basic Truths help to motivate people.

It is a well-accepted fact that people are always interested in knowing about and remaining updated about various kinds of Facts and Feats, and that such Facts and Feats continue to interest people, and several institutions, organizations, business houses continue to record and publish such Facts and Feats.

It is accepted that, traditionally, it has always been such publishers who have been the ones to have recorded and published such WISDOM BYTES and that, as individuals, one needs to refer to such publications from time to time, to learn about, or obtain more information about Words of Wisdom, Basic Truths, and/or Facts and Feats.

It is also accepted that such publications are not published as and when new Words of Wisdom, Basic Truths become common usage, as well as when new Facts are discovered and when new Feats are achieved and people therefore have to wait for a long time to receive such updated information regarding the same.

It is also accepted that the recording and publishing of Words of Wisdom, Basic Truths, and/or Facts and Feats is an activity mostly restricted to such publishers, and that, as such, recording and publishing is not an activity conducted by an individual because this activity requires large amount of resources and infrastructure. Consequently, people continue to remain dependent on such publications, which are generally published with updated information according to time schedules decided by such publishers.

It is also an accepted fact that such publications contain static information, and are not customizable, in that, they do not allow the user to build and share a “personalized” databank of such information which may be proprietary and yet unpublished, and to further classify such information by the Source of Information, Type of WISDOM BYTE, Subject, Sub subjects, and which further allows the user to add more information like the Meaning and details of Origin where applicable, Add Image, Animation and/or Sound files to the same, Associate more information in the form of File(s)/URLs/Remarks to the same; Delete unwanted information and Print the stored information.

### BACKGROUND OF THE INVENTION

It is a well-accepted fact that Words of Wisdom and Basic Truths are part of one's daily conversation and are extensively used in education and people like to use Words of Wisdom and Basic Truths in their daily conversation. It is a well-accepted fact that such Words of Wisdom and Basic Truths help to motivate people. Because Words of Wisdom and Basic Truths are useful in general and are popular with one and all, there is a lot of literature written on such topics.

It is a well-accepted fact that new Facts are being discovered and new Feats are being achieved, and that such new Facts and Feats are continuously recorded for the benefit of people and that people like to be aware of the same for personal and/or professional reasons.

It is a well-accepted fact that such WISDOM BYTES continue to educate, inspire and amaze people, and therefore there is a lot of literature written about them, as well as there are several programs that continue to be produced and broadcast through various media like the television, radio, Internet among others, on them.

It is a well-accepted fact that people generally cannot remember a large amount of data whether by classifications or not, without external help, and it would be very helpful if there were to exist a System that would help people to Add, Retrieve, Modify, Delete, Print, Export, Import, Schedule such WISDOM BYTES, thereby helping people to remember such WISDOM BYTES for use in daily life, for motivation, and to increase their knowledge on the same.

Chinese Patent No. CN1172683 relates to a kind of playing cards that has 52 cards of hearts, spades, diamonds and clubs, each including 13 cards from A to K. The Chinese characters represent twelve animals which symbolizes the year in which one is born are divided into 3 groups, each group being put on a set of playing cards. The twelve animals are put on three set of playing card respectively. Each card has an idiom relative to said animal. Said playing cards will enrich the knowledge on idioms for players.

U.S. Pat. No. 6,453,280 relates to an Electronic dictionary capable of identifying idioms, having an idiom processing function which can automatically identify idioms included in a present sentence from text of a first language, and which can output corresponding translated expressions in a second language. The electronic dictionary is operative to perform a technique which comprises an idiom processing operation which makes automatic identification possible by text capturing, sentence segmenting, local parsing and transfer lexicon matching. The electronic dictionary provides intelligent translation at the idiom level.

European Patent Document EP1215656 relates to Idiom handling in Voice Service systems. The grammar of the speech input to a voice service system is normally specified by the voice service system. However, this can produce problems in respect of idioms, such as dates, which are expressed different ways by different users. To facilitate the handling of idioms, a user is permitted to specify their own idiom grammar which is then used by the voice service system to interpret idioms in speech input from that user. Typically, the normal grammar of speech input is specified by grammar tags used to mark up a voice page script interpreted by a voice page browser; in this case, it will generally be the voice browser that is responsible for employing the user-specified idiom grammar to interpret the corresponding idiom in the speech input by the user. The user-specified grammar can be pre-specified directly to the voice browser by the user or fetched by the browser from a remote location on the fly.

Chinese Patent No. CN1086622 relates to a Chinese proverb spelling game comprising of Chinese proverbs spelling cards as an entertainment tool for the learning and exercise of proverbs and phonetic letters features that the chosen basic phonetic syllables are marked on cards falling into one of four groups and blank cards are used as variable phonetic cards. Two dices with special marks are also used. Said limited cards are combined to form unlimited proverbs.

U.S. Pat. No. 6,507,811 provides a method for symbol manipulation in an electronic data processing system that can be used to alter the representation of ages, names, and proverbs in ways that some people find to be highly amusing. Among other advantages, the representation of people's ages can be altered so that a younger person seems older and an older person seems younger, and the representation of people's names can be altered so that they appear to come from other cultures and are descriptive of the person. Similarly, the representation of proverbs can be altered so that they appear to concern matters of individualized interest. In a preferred embodiment, the method of the present invention comprises the steps, using an electronic data processing system, of inputting an expression of age in base 10 notation, converting the expression of age in base 10 notation to an expression of age in an alternate base notation, and outputting the expression of age in the alternate base notation. An alternate preferred embodiment of a method of the present invention comprises the steps, using an electronic data processing system, of inputting an input name and an input adjective, converting the input name to a cognate form, converting the input adjective to a synonym, and outputting the cognate form and the synonym. Another alternate preferred embodiment of a method of the present invention comprises the steps, using an electronic data processing system, of inputting an input phrase and an input adjective, selecting a proverb form corresponding to the input adjective, inserting the input phrase into the proverb form, and outputting the proverb form with the inserted input phrase.

Chinese Patent No. CN1177779 relates to a hand-held Chinese idioms end-to-end serially-connected computer which comprises two portions of keyboard with 36 keys and computer whose internal memory includes 2000 Chinese idioms which are end-to-end serially-connected together. When using, its switch key is pressed, on the screen of computer the first Chinese idiom formed of four Chinese characters can be displayed, then the switch key can be pressed again, the second Chinese idiom can be displayed, then the rest can be done in the same manner, so that said 2000 Chinese idioms can be displayed one-by-one, therefore it is convenient to learn Chinese idioms for people.

The prior art described in the foregoing descriptions have an inherent limitation, in that, they do not allow the users to build their own databank of WISDOM BYTES by well-defined classifications, and further that none of the above prior art assist in the improvement of one's knowledge of WISDOM BYTES by allowing users to take Wisdom Bytes Session(s), and that none of the above prior art allow the users to share such WISDOM BYTES with others.

Therefore, by dint of determined research and intuitive knowledge, our inventor has developed an interactive System that enables users to build (including saving, appending, retrieving, modifying) their own databank of WISDOM BYTES in one or more languages, by well-defined classifications, Translate the same into one or more languages, and which further enables users to improve their knowledge of WISDOM BYTES by means of taking Wisdom Bytes Sessions and Scheduled displays; which further enables users to Export WISDOM BYTES to other users of this System, and which further enables users to Import WISDOM BYTES built by other users of this System.

### BRIEF SUMMARY OF THE INVENTION

An object of the present invention is to provide an interactive System for building (including saving, appending, retrieving, modifying) and sharing one's own databank of WISDOM BYTES for increasing and improving one's own knowledge of such data for use in daily life, in one or more languages, it being accepted that one may want to build (including saving, appending, retrieving, modifying) such data in one or more languages based on one's personal interest and further stored by various classifications like Source of Information, Type of WISDOM BYTE, Subject, and Sub subjects, such classification of data not restricted to any already provided data.

Yet another object of the present invention is to allow users to FIND such data rapidly and efficiently by none or one or more FIND conditions.

Yet another object of the present invention is to allow users to Customize the data by allowing the Modification of the same, allowing the addition of Meaning and details of Origin where applicable, allowing the addition of Bookmark Remarks, Associations, Files, including Media files, URLs and more Remarks to the same.

Yet another object of the present invention is to allow users to Bookmark selected Records as “Favourite” and assign the same to specific users or user groups.

Yet another object of the present invention is to allow users to Navigate efficiently between the Records.

Yet another object of the present invention is to allow users to Modify data individually and Globally, and further selectively.

Yet another object of the present invention is to allow users to share data created by the users using the Export/Import/Print modules, such Exporting/importing/Printing of data capable of being done selectively.

Yet another object of the present invention is to provide users with the utility of Deleting the data, the scope of deleting data being singular or Global, sending the deleted data to the Recycle Bin Module of the System, and further permanently removing the same, singularly or plurally, and/or restoring the same, singularly or plurally.

Yet another object of the present invention is to allow users to invoke a Wisdom Bytes Session(s) using the stored data and finding the same by none or one or more classifications that the user may have used to create and/or Modify such data, and further to use the data selected for the Session(s) as screen savers.

Yet another object of the present invention is to allow the user to Schedule the WISDOM BYTES, using the stored data by finding the stored data to be used, based on none or one or more FIND conditions, to be brought up on the user's computer, including hand held devices, at preset time intervals, with or without Voice.

Yet another object of the present invention is to provide various Reports selectively and having the further utility of customizing the same.

Yet another object of the present invention is to provide the necessary Tools to the user for better customization and maintenance of the System in various ways.

Yet another object of the present invention is to allow one or more module(s)/utility(s) to operate within a browser and/or other viewing and/or processing programs, and which can operate on one or more computers, including hand held devices.

Yet another object of the present invention is to provide a utility for creating, editing, deleting, printing, navigating, finding Masters like User, Source of Information, Type of WISDOM BYTE, Subject and Sub subjects, etc.

Yet another object of the present invention is to provide users with a Translation utility, allowing the user to consider any WISDOM BYTE as a parent language WISDOM BYTE and Translate the same into one or more languages of the user's choice, the translation activity happening from a Translation Module which is invoked in the Wisdom Bytes Bank Module, and further that all of the features and/or utility(s)/functionality(s) of the System remaining common to the translated WISDOM BYTE as would be applicable to the parent language WISDOM BYTE.

Yet another object of the present invention is to allow the user to Print any Record of the user's choice as well as to obtain a plurality of Reports.

Yet another object of the present invention is to provide sufficient security of not allowing the deletion of a Record or a Master that may be in use.

Yet another object of the present invention is to allow the user to input and/or Modify data in the Wisdom Bytes Bank Database/Translation Database by Voice input, with or without a conjunction of input made by keyboard support, and/or to use any other utility(s)/functionality(s) of the System, as may be supported by the System for such use, by Voice Command, and further to allow the user to receive Voice Output of the data so entered/modified by the user in the above Wisdom Bytes Bank Database/Translation Database.

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which, in an illustrative and non-restrictive way, the following are represented:—

FIG. 1 is the diagram of the System block of the present invention.

FIG. 2 is the diagram of the Multiple User System of the present invention

FIG. 3 is the diagram of the Outline of the System Process of the present invention

FIG. 4 is the diagram of the System Function of the Wisdom Bytes Bank Module of the present invention

FIG. 5 is the diagram of the System Operation of the Wisdom Bytes Bank Module of the present invention

FIG. 6 is the diagram of the System State Transition of the Wisdom Bytes Bank Module of the present invention

FIG. 7 is the diagram of the System Function of the Global Association Module of the present invention

FIG. 8 is the diagram of the System Operation of the Global Association Module of the present invention

FIG. 9 is the diagram of the System State Transition of the Global Association module of the present invention

FIG. 10 is the diagram of the System Function of the Global Attachment Module of the present invention

FIG. 11 is the diagram of the System Operation of the Global Attachment Module of the present invention

FIG. 12 is the diagram of the System State Transition of the Global Attachment Module of the present invention

FIG. 13 is the diagram of the System Function of the Wisdom Bytes Session Module of the present invention

FIG. 14 is the diagram of the System Operation of the Wisdom Bytes Session Module of the present invention

FIG. 15 is the diagram of the System State Transition of the Wisdom Bytes Session Module of the present invention

FIG. 16 is the diagram of the System Function of Reports Module of the present invention

FIG. 17 is the diagram of the System Operation of Reports Module of the present invention

FIG. 18 is the diagram of the System State Transition of Reports Module of the present invention

FIG. 19 is the diagram of the System Function of the Global Modification Module of the present invention

FIG. 20 is the diagram of the System Operation of the Global Modification Module of the present invention

FIG. 21 is the diagram of the System State Transition of the Global Modification Module of the present invention

FIG. 22 is the diagram of the System Function of the Global Delete Module of the present invention

FIG. 23 is the diagram of the System Operation of the Global Delete Module of the present invention

FIG. 24 is the diagram of the System State Transition of the Global Delete Module of the present invention

FIG. 25 is the diagram of the System Function of the Global Bookmark/Unbookmark Module of the present invention

FIG. 26 is the diagram of the System Operation of the Global Bookmark/Unbookmark Module of the present invention

FIG. 27 is the diagram of the System State Transition of the Global Bookmark/Unbookmark Module of the present invention

FIG. 28 is the diagram of the System Function of the Export Module of the present invention

FIG. 29 is the diagram of the System Operation of the Export Module of the present invention

FIG. 30 is the diagram of the System State Transition of the Export Module of the present invention

FIG. 31 is the diagram of the System Function of the Import Module of the present invention

FIG. 32 is the diagram of the System Operation of the Import Module of the present invention

FIG. 33 is the diagram of the System State Transition of the Import Module of the present invention

FIG. 34 is the diagram of the System Function of the Wisdom Bytes Scheduler Module of the present invention

FIG. 35 is the diagram of the System Operation of the Wisdom Bytes Scheduler Module of the present invention

FIG. 36 is the diagram of the System State Transition of the Wisdom Bytes Scheduler Module of the present invention

FIG. 37 is the diagram of the System Function of the Recycle Bin Module of the present invention

FIG. 38 is the diagram of the System Operation of the Recycle Bin Module of the present invention

FIG. 39 is the diagram of the System State Transition of the Recycle Bin Module of the present invention

FIG. 40 is the diagram of the System Function of the Tools/Help Menu Options Module of the present invention

FIG. 41 is the diagram of the System Operation of the Tools/Help Menu Options Module of the present invention

FIG. 42 is the diagram of the System State Transition of the Tools/Help Menu Options Module of the present invention

FIG. 43 is the diagram of the System Function of the Translation Module of the present invention

FIG. 44 is the diagram of the System Operation of the Translation Module of the present invention

FIG. 45 is the diagram of the System State Transition of the Translation Module of the present invention

FIG. 46 is the diagram of the System Function of the Global Translation Module of the present invention

FIG. 47 is the diagram of the System Operation of the Global Translation Module of the present invention

FIG. 48 is the diagram of the System State Transition of the Global Translation Module of the present invention

FIG. 49 is the diagram of the System Function of the Master Module of the present invention

FIG. 50 is the diagram of the System Operation of the Master Module of the present invention

FIG. 51 is the diagram of the System State Transition of the Master Module of the present invention

### DETAILED DESCRIPTION OF THE PRESENT INVENTION

A detailed description of the preferred embodiments and best modes for practicing the present invention are described herein.

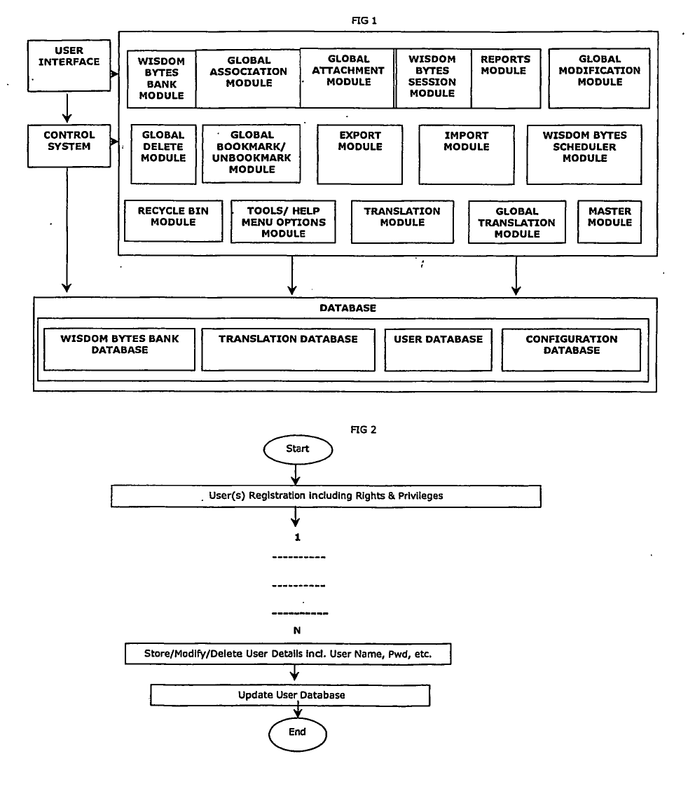

Interactive System for building (including saving, appending, retrieving, modifying) and sharing one's own databank of WISDOM BYTES for increasing and improving one's own knowledge of such WISDOM BYTES in one or more languages, wherein FIG. 1 is the diagram of the different functional blocks and their interaction of the present invention. The User Interface renders the user's actions, and with the help of the Control System transmits the appropriate requests to the Database. The Control System acts as the bridge between the User Interface and the Database.

The Database consists of Wisdom Bytes Bank Database, Translation Database, User Database and the Configuration Database. Wisdom Bytes Bank Database is the reservoir of an extensible collection of well-classified data. The Translation Database is the reservoir of the translated data. The User Database is the reservoir of the user information and also contains the history of past user interaction with the System. The Configuration Database is the reservoir of the options used for the Customization of the System.

If the user requests for the Wisdom Bytes Bank Module through the User Interface, then the Control System asks the Database Management System to find the corresponding data from the Wisdom Bytes Bank Database/Translation Database, resulting in the display of the relevant data, if available. The user then interacts further with the Wisdom Bytes Bank Module through the User Interface.

If the user requests for the Global Association Module through the User Interface, then the Control System asks the Database Management System to find the corresponding data from the Wisdom Bytes Bank Database/Translation Database, resulting in the display of the relevant data, if available. The user then interacts further with the Global Association Module through the User Interface.

If the user requests for the Global Attachment Module through the User Interface, then the Control System asks the Database Management System to find the corresponding data from the Wisdom Bytes Bank Database/Translation Database, resulting in the display of the relevant data, if available. The user then interacts further with the Global Attachment Module through the User Interface.

If the user requests for the Wisdom Bytes Session Module through the User Interface, then the Control System asks the Database Management System to find the corresponding data from the Wisdom Bytes Bank Database/Translation Database, resulting in the display of the relevant data, if available. The user then interacts further with the Wisdom Bytes Session Module through the User Interface.

If the user requests for the Reports Module through the User Interface, then the Control System asks the Database Management System to find the corresponding data from the Wisdom Bytes Bank Database/Translation Database, resulting in the display of the relevant data, if available. The user then interacts further with the Reports Module through the User Interface.

Where any Report relates to user information, then the Control System asks the Database Management System to find the corresponding data from the User Database.

If the user requests for the Global Modification Module through the User Interface, then the Control System asks the Database Management System to find the corresponding data from the Wisdom Bytes Bank Database/Translation Database, resulting in the display of the relevant data, if available. The user then interacts further with the Global Modification Module through the User Interface.

If the user requests for the Global Delete Module through the User Interface, then the Control System asks the Database Management System to find the corresponding data from the Wisdom Bytes Bank Database/Translation Database, resulting in the display of the relevant data, if available. The user then interacts further with the Global Delete Module through the User Interface.

If the user requests for the Global Bookmark/Unbookmark Module through the User Interface, then the Control System asks the Database Management System to find the corresponding data from the Wisdom Bytes Bank Database/Translation Database, resulting in the display of the relevant data, if available. The user then interacts further with the Global Bookmark/Unbookmark Module through the User Interface.

If the user requests for the Export Module through the User Interface, then the Control System asks the Database Management System to find the corresponding data from the Wisdom Bytes Bank Database/Translation Database resulting in the display of the relevant data, if available. The user then interacts further with the Export Module through the User Interface.

If the user requests for the Import Module through the User Interface, then the Control System retrieves the corresponding data from a valid database file resulting in the display of the relevant data, if available. The user then interacts further with the Import Module through the User Interface.

If the user requests for the Wisdom Bytes Scheduler Module through the User Interface, then the Control System asks the Database Management System to find the corresponding data from the Wisdom Bytes Bank Database/Translation Database, resulting in the display of the relevant data, if available. The user then interacts further with the Wisdom Bytes Scheduler Module through the User Interface.

If the user requests for the Recycle Bin Module through the User Interface, then the Control System asks the Database Management System to find the corresponding data from the Wisdom Bytes Bank Database/Translation Database and retrieves the corresponding data resulting in the display of the relevant data, if available. The user then interacts further with the Recycle Bin Module through the User Interface.

If the user requests for the Tools/Help Menu Options Module through the User Interface, then the Control System retrieves the corresponding Options available from the Configuration Database. The user then interacts further with the Tools/Help Menu Options through the User Interface.

If the user requests for the Translation Module through the User Interface, then the Control System asks the Database Management System to find the corresponding data from the Wisdom Bytes Bank Database/Translation Database resulting in the display of the relevant data, if available. The user then interacts further with the Translation Module through the User Interface.

If the user requests for the Global Translation Module through the User Interface, then the Control System asks the Database Management System to find the corresponding data from the Wisdom Bytes Bank Database/Translation Database resulting in the display of the relevant data, if available. The user then interacts further with the Global Translation Module through the User Interface.

If the user requests for the Master Module through the User Interface, then the Control System asks the Database Management System to find the corresponding data from the Wisdom Bytes Bank Database/Translation Database, resulting in the display of the relevant data, if available. The user then interacts further with the Master Module through the User Interface. The relevant databases are updated on Adding, Modifying, and/or Deleting.

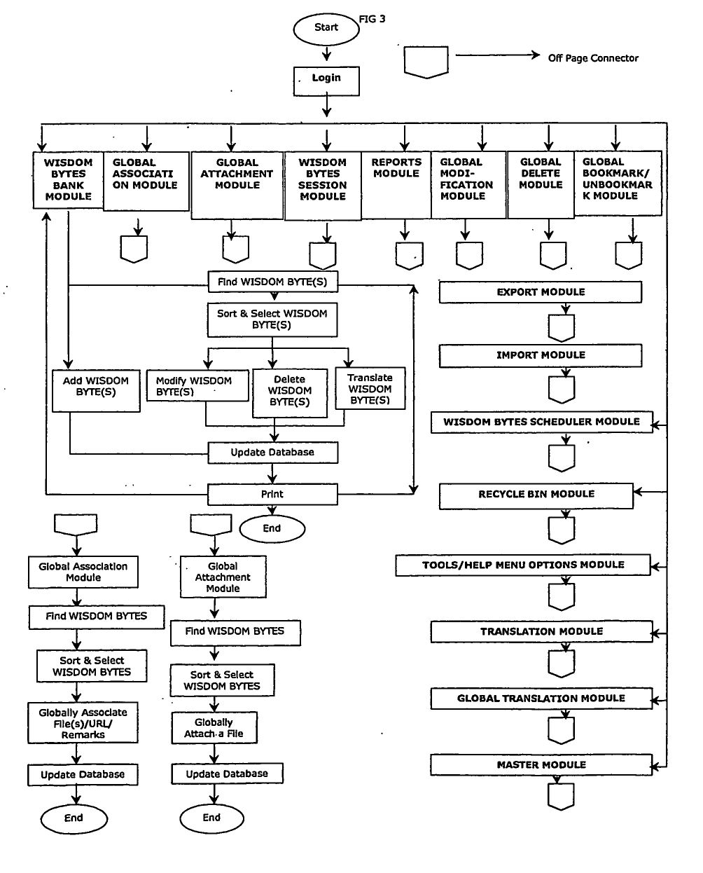

FIG. 2 is the diagram of the Multiple User System of the present invention. It explains that multiple users can use the system at the same time, and also explains that the system can be controlled by rights and privileges. It further allows to Store/Modify/Delete the User Details including User Name, Password etc. in the User Database.

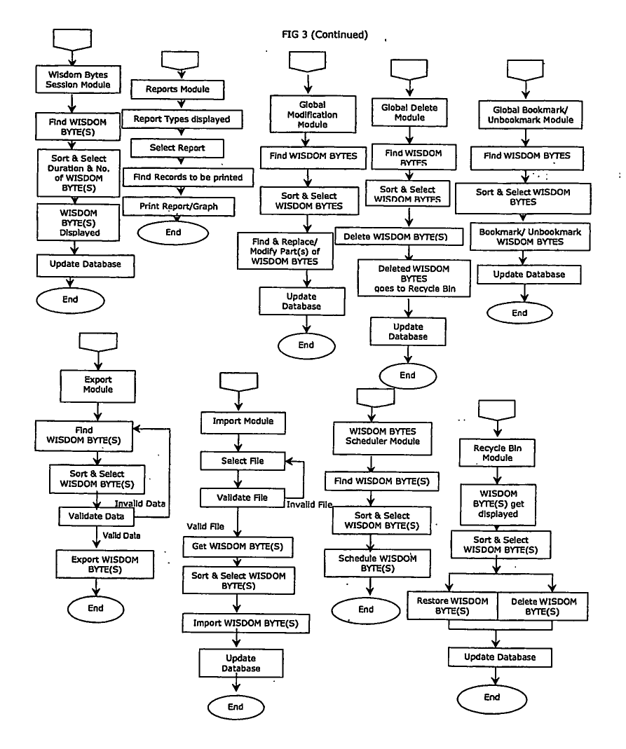

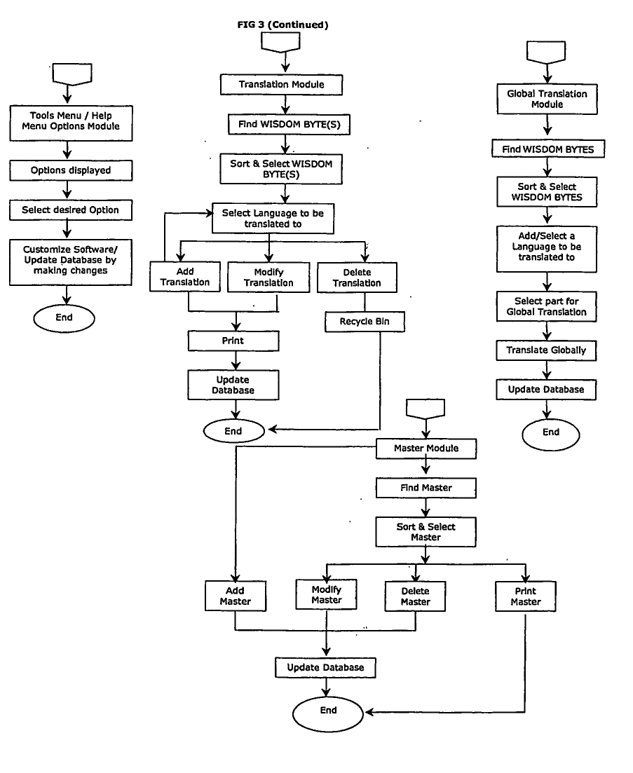

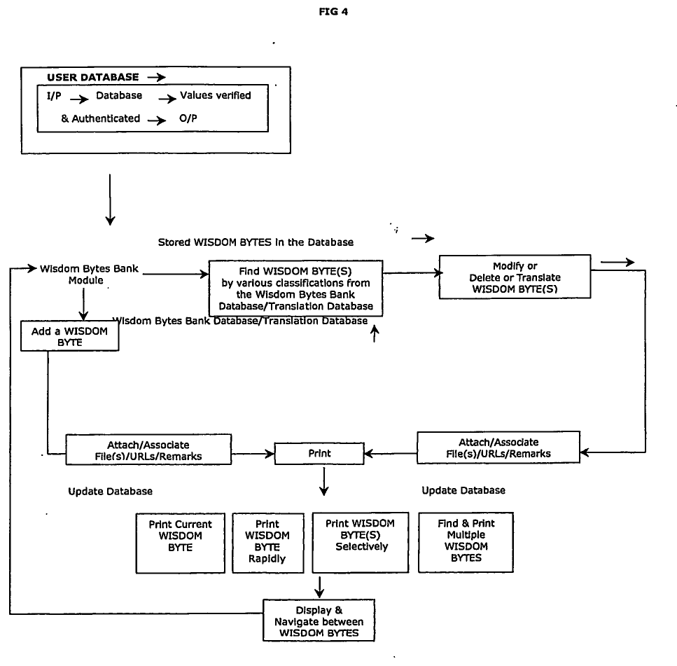

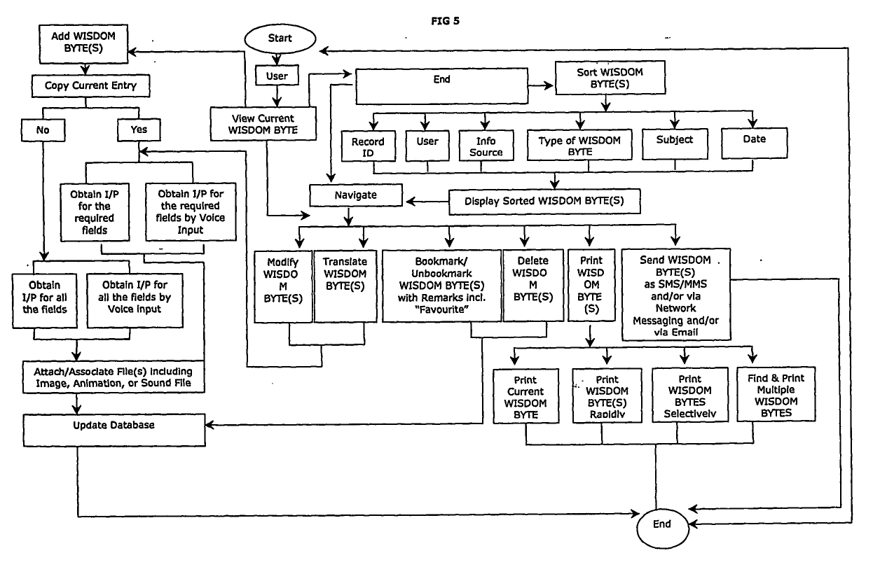

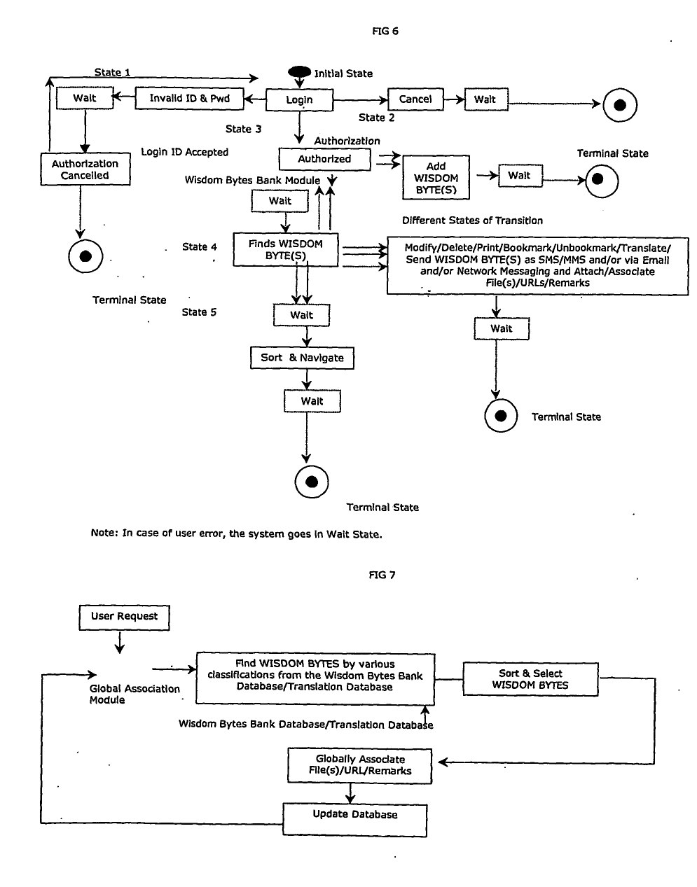

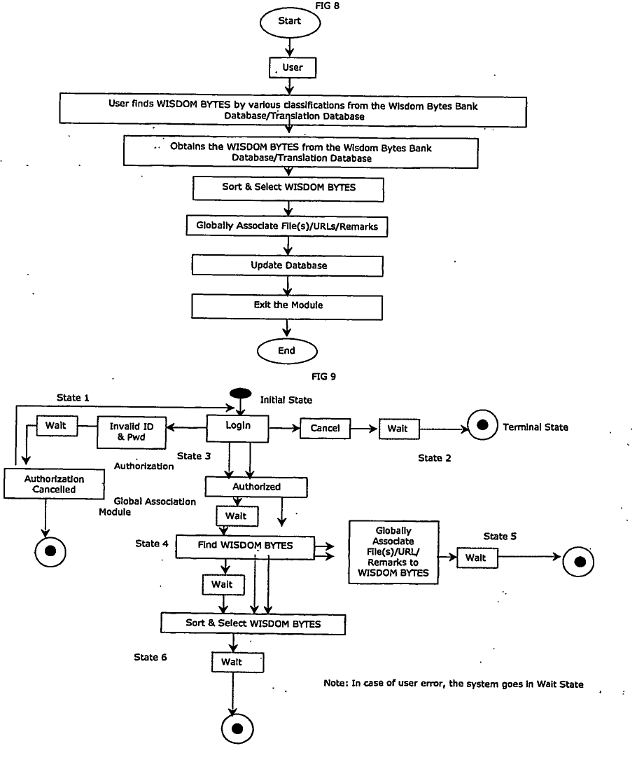

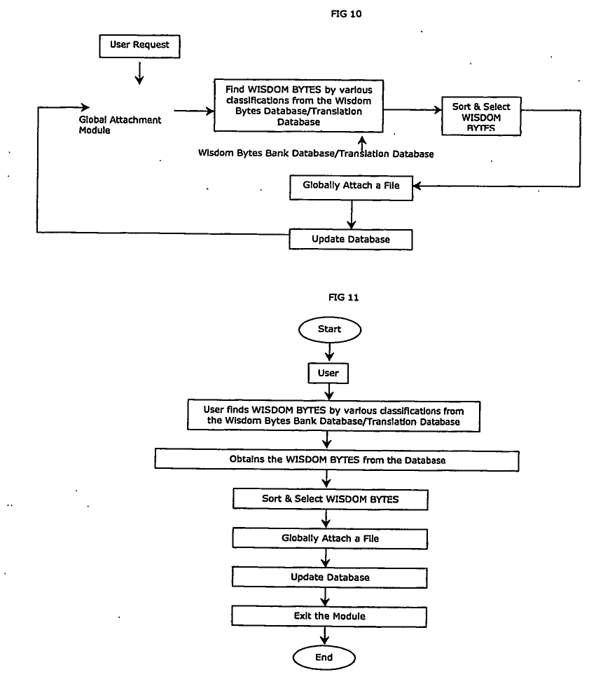

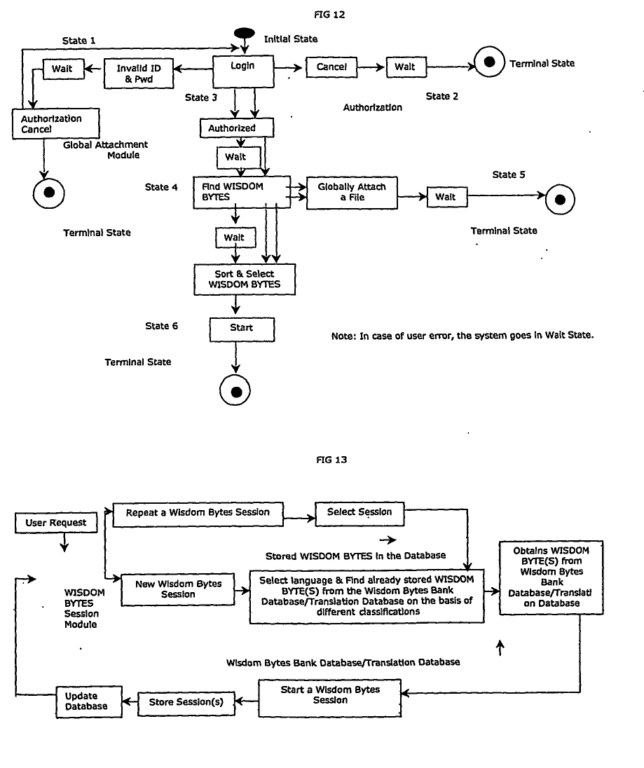

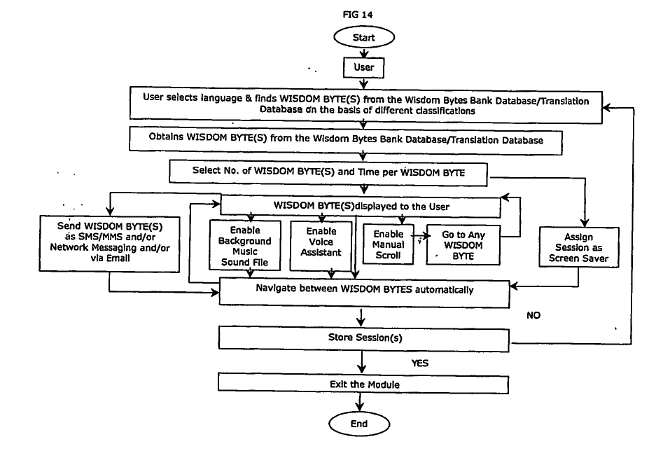

FIG. 3 is the diagram of the outline of the System process of the present invention. It exhibits the modules of the System and their main functions.

FIGS. 4 to 12 explain the System Function, System Operation, System State Transition of the Wisdom Bytes Bank Module, the System Function, System Operation, System State Transition of the Global Association Module, the System Function, System Operation, System State Transition of the Global Attachment Module, respectively of the present invention. The Wisdom Bytes Bank Module accepts data in one or more languages (such data capable of being accepted from more than one user at the same time), with or without voice, by well-defined classifications like (1) Date (2) Source of Information (to record the Source from where the user obtained the details the User is entering—EXAMPLE—The User may have read a SAYING etc. in a particular book or magazine—say “XYZ” and would like to store this Source of Information), (3) Type of WISDOM BYTE (to record the Type of data the user is entering, e.g. adages, aphorisms, dictums, epigrams, expressions, gospels, home truths, idioms, mantras, mottos, nuggets, phrases, proverbs, quotes, quotations, sayings, slogans, Basic Truths, Facts, Feats—EXAMPLE—the data may be in the form of a “ADAGE” like “Look before you Leap” and the user may like to store the same under Type “ADAGE”), (3) Subject (to record the Subject under which the data that the user is entering is to be stored—EXAMPLE—The user is entering a FACT which may be a GEOGRAPHICAL FACT and the user may want to store the FACT under the SUBJECT GEOGRAPHICAL FACTS) (4) Sub Subject(s) (to record the Sub Subject (s) under which the details that the user is entering is to be stored—EXAMPLE—The FACT may be based on a GEOGRAPHICAL SUBJECT and the user may want to store the FACT “Though Mt. Everest is called the tallest mountain on earth, Mauna Kea, a volcano on the island of Hawaii is actually taller”, under the SUBJECT GEOGRAPHICAL FACTS and further classify the same up to 5 levels {Sub-Subjects} e.g. SUBJECT GEOGRAPHICAL FACTS>SUB-SUBJECT1>EARTH GEOGRAPHY>SUB-SUBJECT2>FEATURES>SUB-SUBJECT3>LAND MASSES>SUB-SUBJECT4>MOUNTAINS>SUB-SUBJECT5>TALLEST MOUNTAIN. The Module further allows the user to search for existing WISDOM BYTES by none or one or more of the above classifications, in order to avoid the duplication of entries.

The Module further allows the user to add the meaning and the origin of the Wisdom Byte—EXAMPLE—the idiom “FOOD FOR THOUGHT” means “An interesting idea, worth thinking about”. This idiom originated in the early 1800s when people associated the mind as a mouth that “chews” ideas, thereby making “ideas” as the “FOOD FOR THOUGHT”. The Module further allows the user to Attach and/or Associate any kind of additional information like File(s), URLs and Remarks, File(s) and URLs being able to be opened by the System, the Remarks being simply displayed—EXAMPLE—The user may want to Attach an IMAGE and/or an ANIMATION and/or a SOUND file to the Record, or the user may also want to “associate” more information to the Record by means of associating some information that may be on a file or a Web Site, and hence the user would Associate a file or URL to the Record. Such file(s) would be opened by the System. In case of a URL, the same would be opened by the System provided the user is connected to the Internet. The user may also simply wish to add a REMARK to the Record. Such REMARKS are displayed to the user on demand using a browser.

The System also provides a utility to add specialized Remarks as “Bookmark Remarks”, as well as a utility to Bookmark any selected Record(s) as “Favourite” and further assign the same to specific users or user groups. A Global utility allows the user to Bookmark a set of Records as “Favourite” Globally, across multiple Record(s), by finding the same from the Wisdom Bytes Bank Database/Translation Database, by none or one or more FIND conditions, instead of Bookmarking the same one by one.

All of the above classifications and additional details and information are user defined, and can be modified to suit the user, thereby providing full flexibility to the user.

The System also comprises of the utility, while adding a new data Record, of copying an existing entry with respect to at least the above classifications under which the entry may have been stored, such “Copy Current Entry” utility being of immense use to the user to simplify the creation of Records having at least common classifications.

The System also comprises of the utility of Printing a Record stored in the Wisdom Bytes Bank Database/Translation Database. The Records can be Printed by finding the same from the Wisdom Bytes Bank Database/Translation Database based on none or one or more FIND conditions, the Results being displayed to the user in a grid format with a further utility to Sort the Results, Ascending or Descending, by the relevant classifications, and further allowing the user to select the Records to be Printed from the result grid. The Printing utility offers further selections to be made by the user with respect to various Print conditions such as Printing a single Record, or Printing the results without further selections, or Printing the results selectively, or Printing the entire set of Records available in the database with further selections, if needed. The Printing utility further comprises of the Print reports to be Exported to various destinations in various file formats. The Printing utility provides the user with the ability to customize the Header and Footer details.

The System also comprises of the utility of Navigating between Records in the Wisdom Bytes Bank Database/Translation Database.

The System comprises of the utility of finding Records in the Wisdom Bytes Bank Database/Translation Database, by none or one or more of the above classifications and/or keywords, File Attachments or Bookmark Remarks including, but not limited to, whether the Wisdom Bytes is Bookmarked as “Favourite”, the Find Results being displayed to the user in a grid format with a further utility to Sort the Find Results, Ascending or Descending, by the relevant classifications that may have been used by the user to enter and/or Modify the Records in the Wisdom Bytes Bank Module. Double clicking on any Record will take the user to the concerned Record.

A further utility allows the user to send the Record as SMS/MMS and/or via Email and/or Network Messaging.

The user is allowed to input and/or Modify data in Wisdom Bytes Bank Database/Translation Database by Voice input, with or without a conjunction of input made by keyboard support, and/or use any other utilities/functionality of the System, as may be supported by the System for such use, by Voice Command, and further that the text to speech technology used enables the System to speak out the data so entered/modified by the user in the above Wisdom Bytes Bank Database/Translation Database. The Wisdom Bytes Bank Module also accepts data built by another user (Exporting user) of the System, by the above classifications, and which data may be further manipulated by the Importing user to suit the Importing user's requirements—EXAMPLE—the Exporting user may have classified the subject of the Fact “Though Mt. Everest is called the tallest mountain on earth, Mauna Kea a volcano on the island of Hawaii is actually taller” as GEOGRAPHICAL FACTS, but the Importing user may like to classify the subject of the same as GEOGRAPHY OF NORTH AMERICA.

Any data from the Wisdom Bytes Bank Database/Translation Database can be deleted by the user by finding the same based on none or one or more FIND conditions.

Any Record can be translated by the user into one or more languages by finding the same from the Wisdom Bytes Bank Database/Translation Database based on none or one or more FIND conditions and translating the same into the selected language.

Any data entered or imported into the Wisdom Bytes Bank Module is further used as part of the functions of the other Modules of the System.

FIG. 4 is the diagram of the System Function of the Wisdom Bytes Bank Module of the present invention. The architecture of this Module comprises the following functions, which allow a user to build, append, save, Modify and Delete WISDOM BYTES by well-defined classifications, and add other details like Meanings and details of Origin (where applicable), Attach/Associate Files/URLs/Remarks, with the help of the User Interface.

The Wisdom Bytes Bank Module through the User Interface causes the Control System to find and retrieve the relevant data from the Wisdom Bytes Bank Database/Translation Database. The Module allows a user to:

Find existing data by none or one or more FIND conditions
Sort & Select data
Add, Modify, Delete & Save data by classifications
Translate data
Send data as SMS/MMS and/or Network Messaging and/or via Email
Copy Current Entry
Print Current Wisdom Byte by different classifications
Go To a Wisdom Byte and Navigate between Wisdom Bytes
Bookmark/Unbookmark Wisdom Bytes with various Remarks, as well as Bookmark the same as “Favourite”
Attach/Associate File(s)/URL/Remarks to a Wisdom Byte

FIG. 5 describes the System Operation of the Wisdom Bytes Bank Module explaining that the Module is based on user actions, which are performed by loops.

The Add functionality allows the user to Input data in the relevant fields. The functionality is controlled through a top-level loop. The Control System updates the Database and then the System waits for the next user action.

The Find functionality is controlled through a top-level loop wherein the user is asked to enter/select a find criterion, to bring forth WISDOM BYTE(S) from the Wisdom Bytes Bank Database/Translation Database based on the Find criteria. After finding the WISDOM BYTE(S), the user can sort the WISDOM BYTES etc. by different classifications and then can Modify, Delete or Print the WISDOM BYTE(S). After Modification, if the user saves the WISDOM BYTE(S), the database gets updated and then the System waits for the next user action. Similarly, after deleting a WISDOM BYTE(S), the database gets updated and then the System waits for the next user action.

The Copy Current Entry functionality is controlled through a top-level loop. The System comprises of this utility, while creating a new data Record, of copying an existing entry with respect to at least the above classifications under which the entry may have been stored, such “Copy Current Entry” utility being of immense use to the user to simplify the creation of Records having at least common classifications—EXAMPLE—If a user has an existing Record classified as:

TYPE OF WISDOM BYTE: FACT

SUBJECT: GEOGRAPHICAL FACTS

And the new Record being entered by the User also happens to be falling under the above classifications, the “Copy Current Entry” would make the new entry easier for the user, in that, the user would not have to reclassify the new entry.

The Control System updates the new WISDOM BYTE in the Database and then the System waits for the next user action.

The Printing functionality is controlled through a top-level loop. The user can Print the WISDOM BYTE facing the user, or can Print WISDOM BYTES that may have been found from the Wisdom Bytes Bank Database/Translation Database by a FIND criterion. The Control System retrieves the WISDOM BYTE(S) from the Database and then the System waits for the next user action.

The Bookmark/Unbookmark WISDOM BYTES functionality is controlled through a top-level loop. The user can Bookmark/Unbookmark the WISDOM BYTE facing the user, or can Bookmark/Unbookmark WISDOM BYTE(S) that may have been found from the Wisdom Bytes Bank Database/Translation Database by a FIND criterion. Bookmarking requires that the user add some Remarks to the Bookmark. The Control System updates the Database and then the System waits for the next user action.

This functionality also allows the user to Bookmark WISDOM BYTES as “Favourite”

The Translation functionality is controlled through a top-level loop. The user can Translate WISDOM BYTE facing the user, or can Translate WISDOM BYTE(S) that may have been found from the Wisdom Bytes Bank Database/Translation Database by a FIND criterion. The Translation functionality allows the user to consider any WISDOM BYTE as a parent language WISDOM BYTE and translate the same into one or more languages of the user's choice. The Control System updates the Database and then the System waits for the next user action.

The user can send as SMS/MMS and/or Network Messaging and/or via Email the WISDOM BYTE facing the user, or can send that may have been found from the Wisdom Bytes Bank Database/Translation Database by a FIND criterion.

The user can Attach/Associate file (s) including Image, Animation and/or Sound Files/URL/Remarks to the WISDOM BYTE facing the user, or can Attach/Associate file (s) including Image, Animation and/or Sound Files, URLs/Remarks to the WISDOM BYTES that may have been found from the Wisdom Bytes Bank Database/Translation Database by a FIND criterion. The Attach/Associate file (s) including Image, Animation and/or Sound Files, URL/Remarks functionality to a desired WISDOM BYTE(S) is controlled through a top-level loop. The Control System updates the Database and then the System waits for the next user action.

The Navigation functionality allows the user to navigate between WISDOM BYTES

On giving the Close command the System gets notified and the user comes out from the Module.

FIG. 6 describes the System State Transition Diagram of the Wisdom Bytes Bank Module explaining that the Module is based on the different States.

The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

FIG. 7 is the diagram of the System Function of Global Association Module of the present invention. The architecture of this Module comprises the following functions, which allow a user to Associate File(s)/URL/Remarks to WISDOM BYTES Globally by finding the WISDOM BYTES from the Wisdom Bytes Bank Database/Translation Database, by none or one or more FIND conditions with the help of the User Interface. The Global Association Module, through the User Interface, causes the Control System to find and retrieve the relevant data from the Wisdom Bytes Bank Database/Translation Database and to Associate File(s)/URLs/Remarks to WISDOM BYTES Globally across several selected WISDOM BYTES at a time.

FIG. 8 describes the System Operation of Global Association Module explaining that the Module is based on user actions, which are performed by loops. Through this Global Association Module, the user can Associate File(s)/URL/Remarks to WISDOM BYTES Globally by finding the WISDOM BYTE(S) from the Wisdom Bytes Bank Database/Translation Database, by none or one or more FIND conditions with the help of the User Interface.

Once the user finds the WISDOM BYTES from the Wisdom Bytes Bank Database/Translation Database, by various classifications, the user can sort & select the WISDOM BYTE(S) and then the System waits for the next user action. Then the user can Associate File(s)/URLs/Remarks to WISDOM BYTES Globally through the User Interface. The System then waits for the next user action.

On giving the Close command the System gets notified and the user comes out from the Module.

FIG. 9 describes the System State Transition Diagram of the Global Association Module explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

FIG. 10 is the diagram of the System Function of Global Attachment Module of the present invention. The architecture of this Module comprises the following functions, which allow a user to Attach a File to WISDOM BYTES Globally by finding the WISDOM BYTE(S) from the Wisdom Bytes Bank Database/Translation Database, by none or one or more FIND conditions with the help of the User Interface. The Global Attachment Module, through the User Interface, causes the Control System to find and retrieve the relevant data from the Wisdom Bytes Bank Database/Translation Database and to Attach File(s) to the WISDOM BYTES Globally across several selected WISDOM BYTE(S) at a time.

FIG. 11 describes the System Operation of Global Attachment Module explaining that the Module is based on user actions, which are performed by loops. Through this Global Attachment Module, the user can Attach File(s) to WISDOM BYTES Globally by finding the WISDOM BYTE(S) from the Wisdom Bytes Bank Database/Translation Database, by none or one or more FIND conditions with the help of the User Interface.

Once the user finds the WISDOM BYTES from the Wisdom Bytes Bank Database/Translation Database, by various classifications, the user can sort & select the WISDOM BYTE(S) and then the System waits for the next user action. Then the user can Attach File(s) to WISDOM BYTES Globally through the User Interface. The System then waits for the next user action.

On giving the Close command the System gets notified and the user comes out from the Module.

FIG. 12 describes the System State Transition Diagram of the Global Attachment Module explaining that the Module is based on the different States. The system receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

The System generates a new Record Id each time a new entry is made by a user or when a Record is imported by the user.

FIGS. 13 to 15 explain the System Function, System Operation and System State Transition respectively, comprises of a Module allowing the user to invoke and store a Wisdom Bytes Session, (such Wisdom Bytes Sessions being capable of being taken by more than one user at the same time), using the data stored in the Wisdom Bytes Bank Database/Translation Database, and by finding the same based on none or one or more FIND conditions, the find results being displayed to the user with a Timer, the time of display as may be selected by the user, for displaying each of the Records, and the Records being displayed one by one, until the number of Records found by the above FIND conditions are exhausted, or until the user exits the Module, as well as further allowing the user to manually navigate between the Records being used in the Wisdom Bytes Session, as well as further allowing the user to make a selection as to whether the user wishes to listen to the Background Music Sound File during the Wisdom Bytes Session, as well as further allowing the user to make a selection as to whether the user wishes to listen to the text of the WISDOM BYTE(S), which is simultaneously displayed and spoken by a character through an embedded text to speech engine. The Module further comprises of the utility of allowing the user to select the number of Records that the user wishes to use for the Wisdom Bytes Session, the Records being randomly selected from the database, but based on the FIND conditions, and displayed to the user on the user's computers, including hand held devices. The Module further comprises of the utility of allowing the user to repeat the Wisdom Bytes Session from the previously stored Wisdom Bytes Session(s). The Module further comprises of the utility of allowing the user to assign any previous Wisdom Bytes Session as the data input for the purpose of showing the data on the user's screen as a screen saver. A further utility allows the user to send the Record as SMS/MMS and/or via Email and/or Network Messaging during the Wisdom Bytes Session.

FIG. 13 is the diagram of the System Function of Wisdom Bytes Session Module of the present invention. The architecture of this Module comprises the following functions, which allow a user to invoke a new Wisdom Bytes Session using the data stored in the Wisdom Bytes Bank Database/Translation Database, and by finding the same based on none or one or more FIND conditions, to Repeat a Wisdom Bytes Session with the help of the User Interface.

The Wisdom Bytes Session through the User Interface causes the Control System to find and retrieve the relevant data from the Wisdom Bytes Bank Database/Translation Database. The Module allows a user to:
Select a language
Take a New Wisdom Bytes Session by finding the WISDOM BYTE(S) from the Wisdom Bytes Bank Database/Translation Database, by none or one or more FIND conditions
Repeat a Wisdom Bytes Session
Navigate manually(Manual Scroll) or automatically (AutoScroll) between WISDOM BYTES during the Wisdom Bytes Session
Activate Background Music Sound File during the Wisdom Bytes Session
Activate Voice Assistant during the Wisdom Bytes Session
Send WISDOM BYTE(S) as SMS/MMS and/or Network Messaging and/or via Email during the Wisdom Bytes Session

FIG. 14 describes the System Operation of the Wisdom Bytes Session Module explaining that the Module is based on user actions, which are performed by loops.

To invoke a New Wisdom Bytes Session, the user selects the language, User Name, Wisdom Bytes Session Title, No. of WISDOM BYTE(S) and Time per WISDOM BYTE and then finds the WISDOM BYTE(S) from the Wisdom Bytes Bank Database/Translation Database, by none or one or more FIND conditions. The System then waits for the next user action. The user can also listen to the Background Music Sound File or can activate the Voice Assistant during the Wisdom Bytes Session. The System then waits for the next user action. The user can also assign any previous Wisdom Bytes Session for the purpose of showing the data on the user's screen as a screen saver. The user can also navigate between the WISDOM BYTES and can also jump to any WISDOM BYTE at any point of time during the Session, and after this the user can notify the System that the Session is finished. The System stores the Wisdom Bytes Session and the database gets updated. The user can also send the WISDOM BYTE(S) as SMS/MMS and/or Network Messaging and/or via Email. The System then waits for the next user action.

To Repeat a Wisdom Bytes Session, the user selects the desired Wisdom Bytes Session from the previously stored Wisdom Bytes Session(s) containing the User Name and the Wisdom Bytes Session Title. The System then waits for the next user action.

On giving the Close command the System gets notified and the user comes out from the Module.

FIG. 15 describes the System State Transition Diagram of the Wisdom Bytes Session Module explaining that the Module is based on the different States.

The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

FIGS. 16 to 18 explain the System Function, System Operation and System State Transition respectively of the utility of obtaining the following Reports:
List of WISDOM BYTES
List of WISDOM BYTES Count by Category
User Details

FIG. 16 is the diagram of the System Function of Reports Module of the present invention. The architecture of this Module comprises the following functions, which allow a user to print Reports and/or Graphs (In case of WISDOM BYTES Count by Category and WISDOM BYTES Count by Multiple Categories) by finding the Records from the Wisdom Bytes Bank Database/Translation Database, by none or one or more FIND conditions with the help of the User Interface.

The Reports Module, through the User Interface, causes the Control System to find and retrieve the relevant data from Wisdom Bytes Bank Database/Translation Database. The Module allows a user to:
Select a Report Type
Find existing WISDOM BYTE(S) from the Wisdom Bytes Bank Database/Translation Database, by none or one or more FIND conditions to be printed
Print Report/Graph

FIG. 17 describes the System Operation of Reports Module explaining that the Module is based on user actions.

The user selects the Report/Graph to be printed and then Finds & Selects the Records from the Wisdom Bytes Bank Database/Translation Database, by none or one or more FIND conditions to be included in this selected Report/Graph. The System waits for the next user action. The user can print the selected criteria, if needed. Then the System waits for the next user action. The user can mark the Records to be printed based on the selected criteria. Then the user is able to print the Records. Then the System waits for the next user action. The user can print the Report and/or Graph based on the selected criteria. The System then waits for the next user action.

On giving the Close command the System gets notified and the user comes out from the Module.

FIG. 18 describes the System State Transition Diagram of the Reports Module explaining that the Module is based on the different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

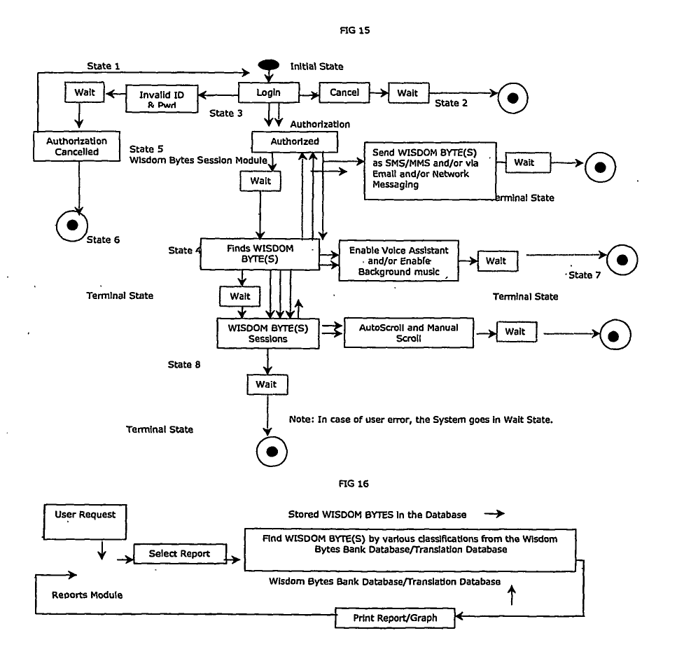

FIGS. 19 to 21 explain the System Function, System Operation and System State Transition respectively of the utility of Modifying a Record stored in the Wisdom Bytes Bank Database/Translation Database—EXAMPLE—The System allows the user to Modify any part of an existing Record by using the Edit utility. A Record entered under the subject GEOGRAPHICAL FACTS, being decided by the user to be Modified, can be instead stored under the subject VOLCANOES. This would hold true to any part of the Record being wanted to be Modified by the user, in that, any part or parts of the Record is allowed to be Modified by the user. There is a further utility of “Global Modification” wherein Record(s) can be “found and Replaced/Modified” Globally. The Records can be Replaced/Modified Globally by finding them from the Wisdom Bytes Bank Database/Translation Database based on none or one or more FIND conditions, the Results being displayed to the user in a grid format with a further utility to Sort the Results, Ascending or Descending, by some of the relevant classifications, and further allowing the user to select the Records to be Globally Replaced/Modified from the result grid.—EXAMPLE—The user may want to change the subject of some or all WISDOM BYTES classified under the subject GEOGRAPHY to the subject HISTORY. The Global utility would perm it the user to make this Modification across multiple WISDOM BYTES instead of Modifying the same one by one.

FIG. 19 is the diagram of the System Function of Global Modification Module of the present invention. The architecture of this Module comprises the following functions, which allow a user to Find & Modify/Replace part(s) of the WISDOM BYTES Globally, as desired, by finding the WISDOM BYTES from the Wisdom Bytes Bank Database/Translation Database by none or one or more FIND conditions with the help of the User Interface.

The Global Modification Module, through the User Interface, causes the Control System to find and retrieve the relevant data from the Wisdom Bytes Bank Database/Translation Database. The Module allows a user to:
Find existing WISDOM BYTES by none or one or more FIND conditions
Sort & Select WISDOM BYTES
Find & Replace/Modify part(s) of WISDOM BYTES Globally

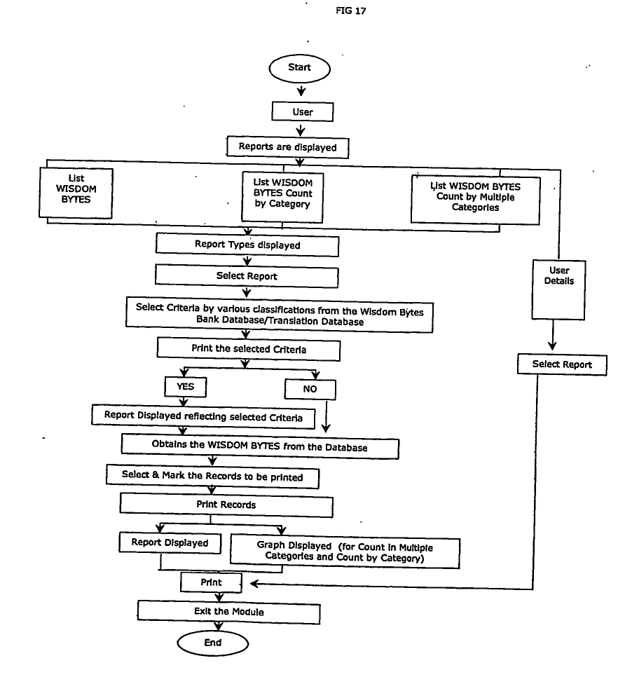

FIG. 20 describes the System Operation of the Global Modification Module explaining that the Module is based on user actions.

Once the user finds the WISDOM BYTES from the Wisdom Bytes Bank Database/Translation Database, by none or one or more FIND conditions the user can sort & select the WISDOM BYTES and then the System waits for the next user action. The Control System retrieves that particular WISDOM BYTE from the Database. Then the user Modifies (Finds & Replaces) part(s) of the selected WISDOM BYTES Globally through the User Interface. The System then waits for the next user action.

On giving the Close command the System gets notified and the user comes out from the Module.

FIG. 21 describes the System State Transition Diagram of the Global Modification Module explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State A transition shown with a dotted line indicates that it is leaving from one State and entering another state.

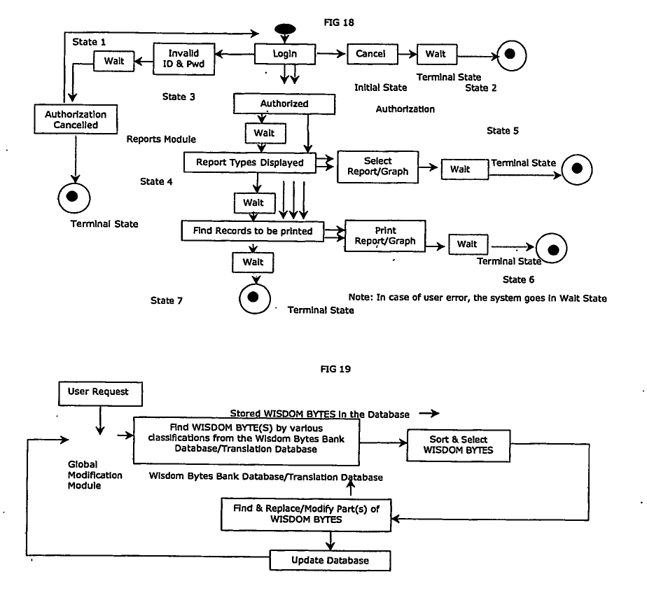

FIGS. 22 to 24 explain the System Function, System Operation and System State Transition respectively of the utility of Deleting a Record stored in the Wisdom Bytes Bank Database/Translation Database, and having the further utility of “Global Delete” wherein the user can select the Records to be Globally Deleted. The Records can be deleted Globally by finding them from the Wisdom Bytes Bank Database/Translation Database based on none or one or more FIND conditions, the Results being displayed to the user in a grid format with a further utility to Sort the Results, Ascending or Descending, by some of the relevant classifications, and further allowing the user to select the Records to be Globally Deleted from the result grid. Any Record deleted is sent to the Recycle Bin Module of the System.

FIG. 22 is the diagram of the System Function of Global Delete Module of the present invention. The architecture of this Module comprises the following functions, which allow a user to Delete WISDOM BYTES Globally by finding the WISDOM BYTES from the Wisdom Bytes Bank Database/Translation Database by none or one or more FIND conditions with the help of the User Interface.

The Global Delete Module, through the User Interface, causes the Control System to find and retrieve relevant data from the Wisdom Bytes Bank Database/Translation Database. The module allows a user to:
Find existing WISDOM BYTES by none or one or more FIND conditions
Sort & Select WISDOM BYTES
Delete WISDOM BYTES Globally (which goes to Recycle Bin of the System)

FIG. 23 describes the System Operation of the Global Delete Module explaining that the Module is based on user actions. Once the user finds the WISDOM BYTES by from the Wisdom Bytes Bank Database/Translation Database, by none or one or more FIND conditions, the user can sort & select the WISDOM BYTES and then the System waits for the next user action. Then the user deletes the selected WISDOM BYTES through the User Interface. The System then waits for the next user action.

On giving the Close command the System gets notified and the user comes out from the Module.

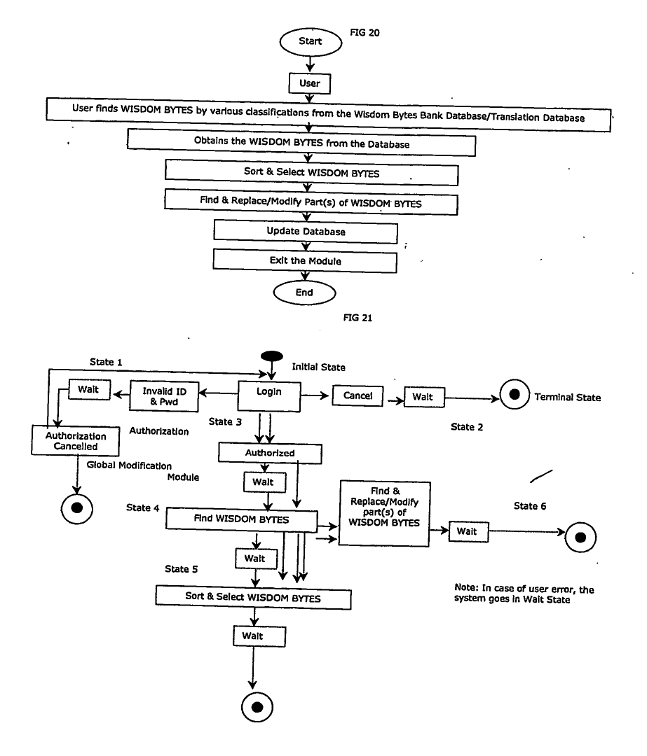

FIG. 24 describes the System State Transition Diagram of the Global Delete Module explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

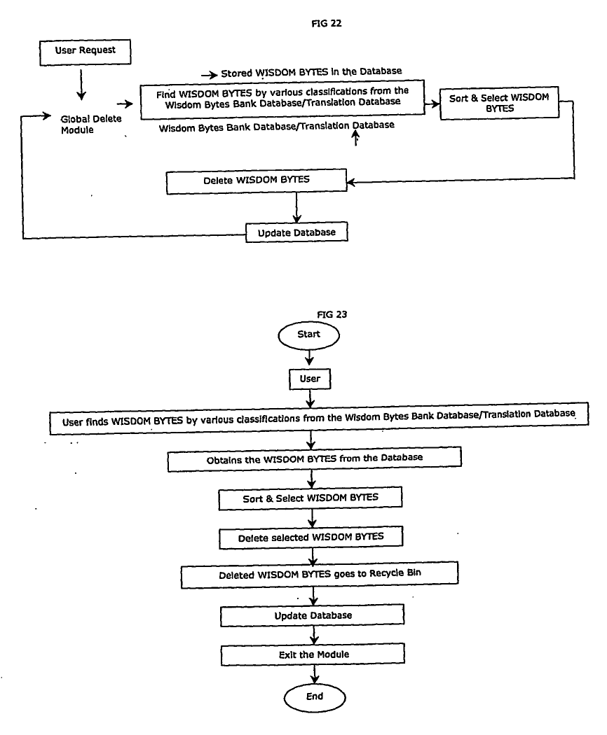

FIGS. 25 to 27 explain the System Function, System Operation and System State Transition respectively of the utility of Bookmarking or Unbookmarking one or more already Bookmarked Records in the Wisdom Bytes Bank Database/Translation Database, and having the further utility of “Global Bookmark/Unbookmark” wherein the user can select the Records to be Globally Bookmarked/Unbookmarked, and where the user can make further selections before actually Globally Bookmarking/Unbookmarking the Records. The Records can be Bookmarked/Unbookmarked Globally, in the Wisdom Bytes Bank Database/Translation Database, by finding the same from the Wisdom Bytes Bank Database/Translation Database based on none or one or more FIND conditions, the Results being displayed to the user in a grid format with a further utility to Sort the Results, Ascending or Descending, by some of the relevant classifications, and further allowing the user to select the Records to be Globally Bookmarked/Unbookmarked, from the result grid. Bookmarking the Records with any kind of Remarks, including, but not limited to Bookmarking the Records with remarks like “Favourite” (indicating that the Records are the user's preferred Records) helps in finding the Records by such Bookmarks.

FIG. 25 is the diagram of the System Function of Global Bookmark/Unbookmark Module of the present invention. The architecture of this Module comprises the following functions, which allow a user to Bookmark/Unbookmark WISDOM BYTES Globally by finding the WISDOM BYTES from the Wisdom Bytes Bank Database/Translation Database by none or one or more FIND conditions with the help of the User Interface.

The Global Bookmark/Unbookmark Module through the User Interface causes the Control System to find and retrieve the relevant data from Wisdom Bytes Bank Database/Translation Database. The Module allows a user to:
Find existing WISDOM BYTES from the Wisdom Bytes Bank Database/Translation Database, by none or one or more. FIND conditions
Sort & Select WISDOM BYTES Global Bookmark/Unbookmark WISDOM BYTES

FIG. 26 describes the System Operation of the Global Bookmark/Unbookmark Module explaining that the Module is based on user actions.

Once the user finds the WISDOM BYTES from the Wisdom Bytes from the Wisdom Bytes Bank Database/Translation Database, by none or one or more FIND conditions, the user can sort & select the WISDOM BYTES and then the System waits for the next user action. The Control System retrieves the particular WISDOM BYTES from the Database. Then the user can Bookmark/Unbookmark the selected WISDOM BYTES through the User Interface. The System then waits for the next user action. Any Bookmark Remarks added through this Module would overwrite the Remarks added through the Wisdom Bytes Bank Module.

On giving the Close command the System gets notified and the user comes out from the Module.

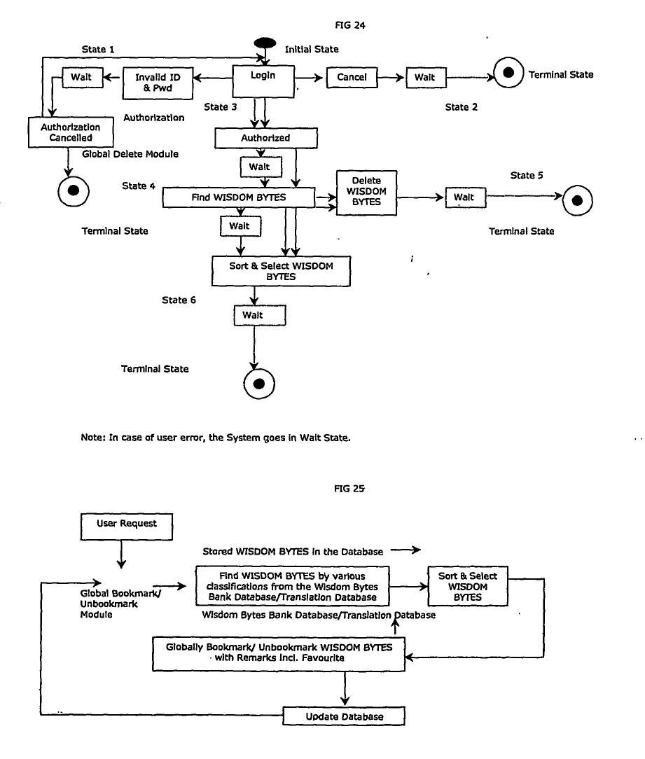

FIG. 27 describes the System State Transition Diagram of the Global Bookmark/Unbookmark Module explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

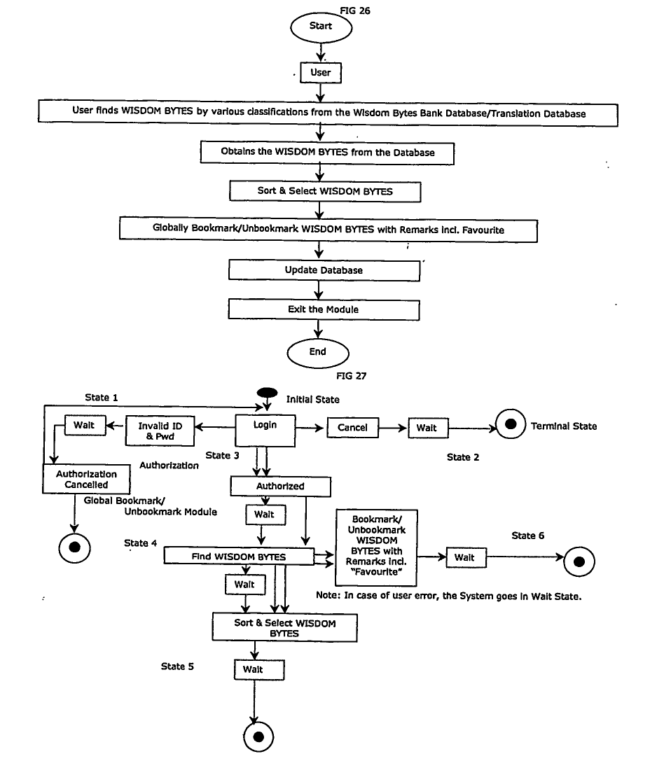

FIGS. 28 to 30 explain the System Function, System Operation and System State Transition respectively of the utility of Exporting Records (by means of a database file created by the System) stored in the Wisdom Bytes Bank Database/Translation Database, by finding the same from the Wisdom Bytes Bank Database/Translation Database, by none or one or more FIND conditions, the Results being displayed to the user in a grid format with a further utility to Sort the Results, Ascending or Descending, by some of the relevant classifications, and further allowing the user to select the Records to be Exported from the result grid. Records can also be Exported to various destinations by using the Print utility. A further utility allows the user to Export the Record(s) as SMS/MMS and/or Email and/or Network Messaging.

FIG. 28 is the diagram of the System Function of Export Module of the present invention. The architecture of this Module comprises the following functions, which allow a user to Export WISDOM BYTE(S) by creating a database file and/or as SMS/MMS and/or via Email and/or Network Messaging with the help of the User Interface.

The Export Module through the User Interface causes the Control System to find and retrieve the relevant data from Wisdom Bytes Bank Database/Translation Database by none or one or more FIND conditions. The Module allows a user to:
Find existing WISDOM BYTE(S) from the Wisdom Bytes Bank Database/Translation Database, by none or one or more FIND conditions
Sort & Select WISDOM BYTE(S)
Validate Data
Export WISDOM BYTE(S) as Database File and/or as SMS/MMS and/or via Email and/or Network Messaging.

FIG. 29 describes the System Operation of Export Module explaining that the Module is based on user actions, which are performed by loops.

Once the user finds the WISDOM BYTE(S) from the Wisdom Bytes Bank Database/Translation Database, by none or one or more FIND conditions, the System returns to the top-level loop, and waits for the next user action. The user can sort & select the desired WISDOM BYTE(S) and then after data validation can Export WISDOM BYTES as Database File and/or as SMS/MMS and/or via Email and/or Network Messaging. The System then waits for the next user action.

On giving the Close command the System gets notified and the user comes out from the Module.

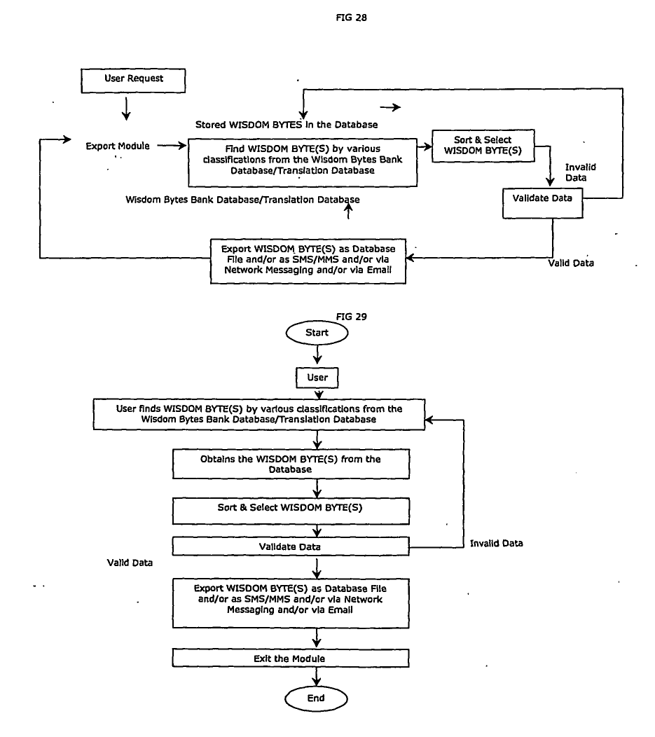

FIG. 30 describes the System State Transition Diagram of the Export Module explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

FIGS. 31 to 33 explain the System Function, System Operation and System State Transition respectively of the utility of Importing Records from a database file that may have been built by another user(s) of this System, with the utility of appending the data already stored by the user in the Wisdom Bytes Bank Database/Translation Database. The utility further comprises of displaying the Importable Records to the user in a grid format with a further utility to Sort the data, Ascending or Descending, by the relevant classifications. The utility further allows the user to make a selection of the data to be imported; thereby allowing the user to Import only such data as may be required.

FIG. 31 is the diagram of the System Function of Import Module of the present invention. The architecture of this Module comprises the following functions, which allow a user to Import WISDOM BYTE(S) with the help of the User Interface from a database file that may have been created by another user(s) of this System.

The Import Module through the User Interface causes the Control System to retrieve the relevant data from a valid Database file. The Module allows a user to:
Select a File
Validate the File
Get WISDOM BYTE(S)
Sort & Select WISDOM BYTE(S)
Import WISDOM BYTE(S)

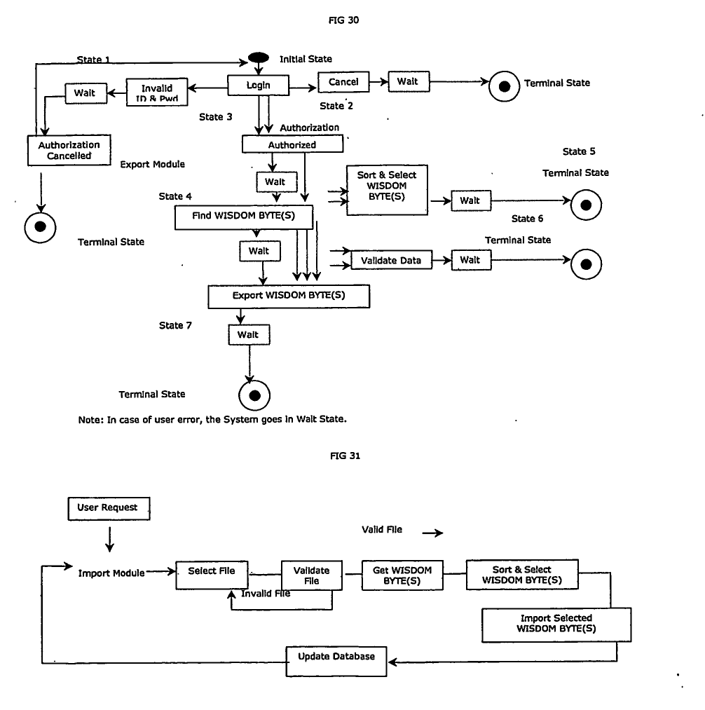

FIG. 32 describes the System Operation of Import Module explaining that the Module is based on user actions, which are performed by loops.

Once the user retrieves the WISDOM BYTE(S) after File Validation, the System returns to the top-level loop, and waits for the next user action. The user can sort & select the desired WISDOM BYTE(S) and can then Import the WISDOM BYTE(S) selectively, if needed. The Database gets updated and the System then waits for the next user action.

On giving the Close command the System gets notified and the user comes out from the Module.

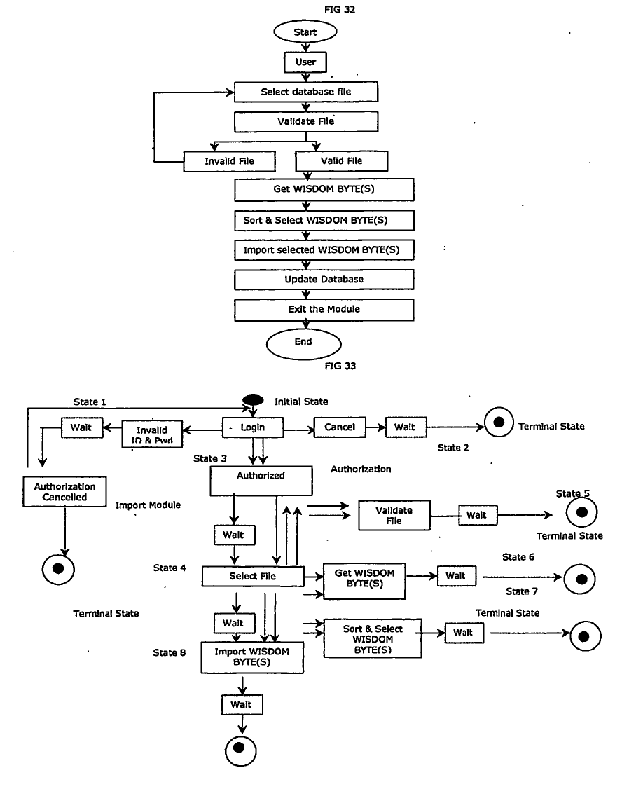

FIG. 33 describes the System State Transition Diagram of the Import Module explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

FIGS. 34 to 36 explain the System Function, System Operation and System State Transition respectively, of the utility of allowing the user to Schedule the WISDOM BYTES by finding the same from the Wisdom Bytes Bank Database/Translation Database, by none or one or more FIND conditions, to be displayed on the user's computer, including hand held devices, at preset time intervals, with or without Voice, in the case of with voice, the text of such WISDOM BYTE(S) being additionally displayed on the user's computer, including hand held devices and simultaneously being spoken by a character, through an embedded text to speech engine and further that the user has the ability to selectively Schedule the WISDOM BYTE(S). A further utility allows the user to send the Record as SMS/MMS and/or via Email and/or Network Messaging at any time before the Scheduling Session is over.

FIG. 34 is the diagram of the System Function of WISDOM BYTES Scheduler Module of the present invention. The architecture of this Module comprises the following functions, which allow a user to find the WISDOM BYTES by from the Wisdom Bytes Bank Database/Translation Database, by none or one or more FIND conditions, and Schedule them as desired with the help of the User Interface.

The WISDOM BYTES Scheduler Module, through the User Interface causes the Control System to find and retrieve the relevant data from the Wisdom Bytes Bank Database/Translation Database. The Module allows a user to:
Select a language
Find existing WISDOM BYTES from the Wisdom Bytes Bank Database/Translation Database, by none or one or more FIND conditions
Sort & Select WISDOM BYTES
Schedule time interval between the selected WISDOM BYTES
Activate Background Music Sound File
Activate Voice Assistant
Send WISDOM BYTE(S) as SMS/MMS and/or via Email and/or Network Messaging when the WISDOM BYTE is displayed
   NOTE: The user can decide whether the Scheduler should remain active in the system tray of the user's computer, irrespective of whether the System is running or not.

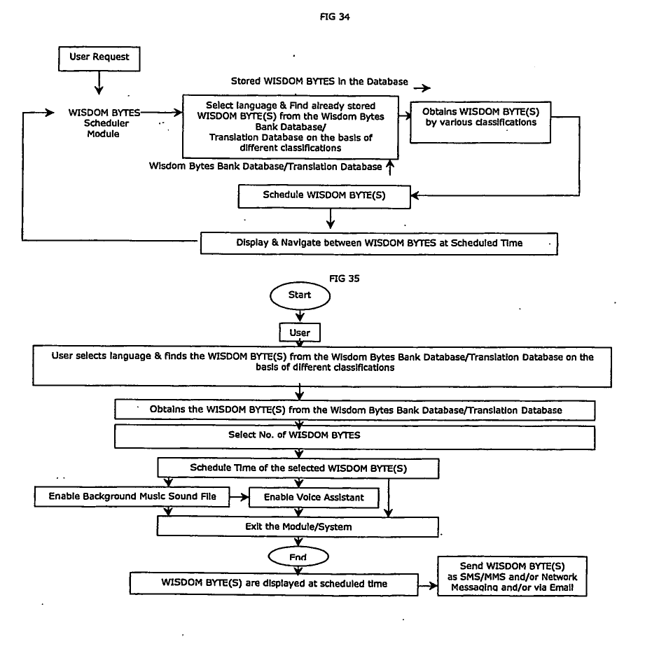

FIG. 35 describes the System Operation of the WISDOM BYTES Scheduler Module explaining that the Module is based on user actions, which are performed by loops.

The user selects the language, No. of WISDOM BYTE(S) and then finds the WISDOM BYTE(S) from the Wisdom Bytes Bank Database/Translation Database, by none or one or more FIND conditions. The System then waits for the next user action. The user can also select to listen to a Background Music Sound File or can select to activate the Voice Assistant during the scheduling activity and after this the user can notify the System that the session is finished. The System then waits for the next user action. The Scheduled WISDOM BYTE(S) gets displayed according to the specified time. The user can also send the WISDOM BYTE(S) as SMS/MMS and/or via Email and/or Network Messaging. The System then waits for the next user action.

On giving the Close command the System gets notified and the user comes out from the Module.

FIG. 36 describes the System State Transition Diagram of the WISDOM BYTES Scheduler Module explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

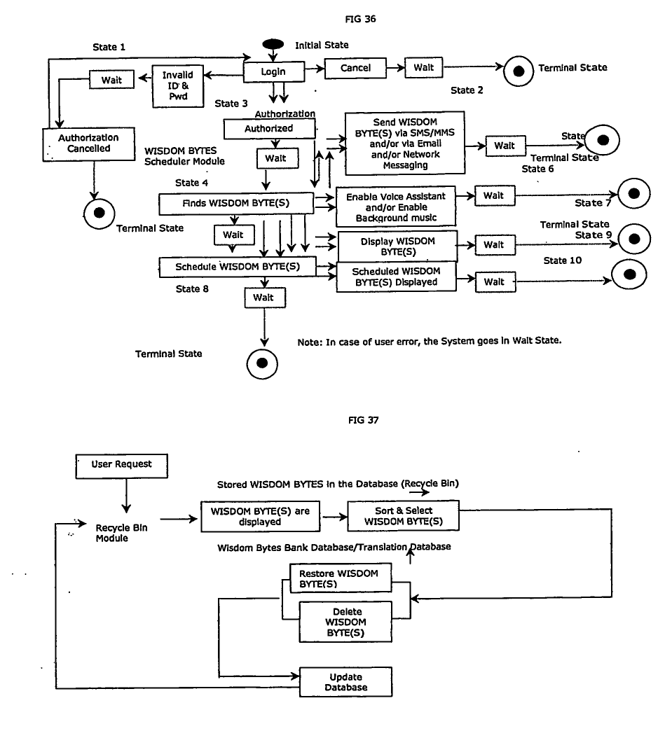

FIGS. 37 to 39 explain the System Function, System Operation and System State Transition respectively, of the utility of Restoring or permanently removing a Record, which may have been deleted by the user from the Wisdom Bytes Bank Database/Translation Database, and having the further utility of selectively Restoring or deleting a Record or a group of Records, the Records being displayed to the user in the Recycle Bin of the System in a grid format with a further utility to Sort the Results, Ascending or Descending, by some of the relevant classifications, and further allowing the user to select the Records to be Deleted or Restored from the result grid.

Any Record that is Restored is sent back to the Wisdom Bytes Bank Database/Translation Database, with its original ID Number. Any Record that is Deleted from the Recycle Bin Module is permanently removed from the System.

FIG. 37 is the diagram of the System Function of Recycle Bin Module of the present invention. The architecture of this Module comprises the following functions, which allow a user to Restore/Delete WISDOM BYTE(S) with the help of the User Interface.

The Recycle Bin Module of the System, through the User Interface, causes the Control System to display the deleted data of Wisdom Bytes Bank Database/Translation Database. The Module allows a user to:
Sort & Select WISDOM BYTE(S)
Restore/Delete WISDOM BYTE(S)

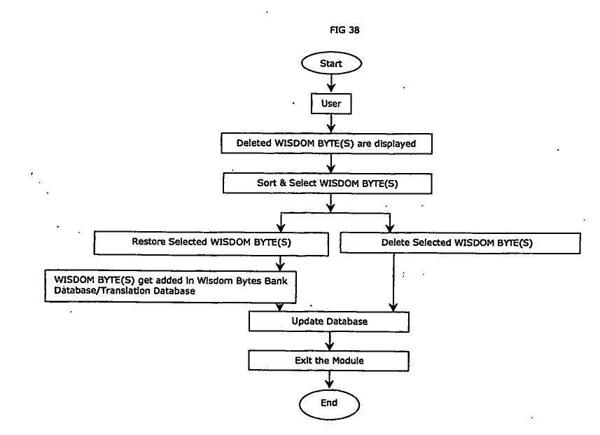

FIG. 38 describes the System Operation of Recycle Bin Module of the System explaining that the Module is based on user actions.

The selection utility of the Recycle Bin Module displays all the WISDOM BYTE(S), that may have been deleted earlier, and still lying in the Recycle Bin of the System. The user can sort & select the displayed WISDOM BYTE(S). The System then waits for the next user action. The user is allowed to either to Delete or Restore the selected WISDOM BYTE(S) through the User Interface. The System then waits for the next user action. The System exercises sufficient caution to ensure that any Record(s) or Master of Records that are in use in a Wisdom Bytes Session or a Scheduled Session are not permanently removed.

On giving the Close command the System gets notified and the user comes out from the Module.

FIG. 39 describes the System State Transition Diagram of the Recycle Bin Module of the System explaining that the Module is based on the different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

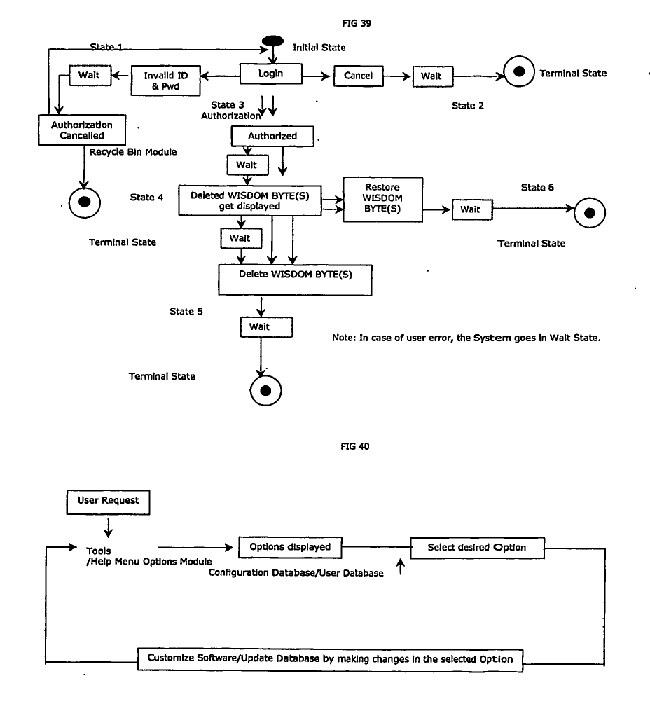

FIGS. 40 to 42 explain the System Function, System Operation and System State Transition respectively, of the Tools/Help Menu Options Module comprising of software maintenance tools such as Back Up, Repair, Restore, Compression of the entire database and System Check. There are other tools such as Start Up options, Data Entry Options, Change Sound, Customize Header and Footer, Graphical User Interface Manager, Labels, Select Skin, Remove Wisdom Bytes Session(s), and Help. The System allows the creation of Sub users who are able to set their own preferences with respect to the relevant tools.

The System wherein one or more Module(s)/utility(s) or program(s) of the same can Operate within a browser and/or other viewing and/or processing programs, and can operate on one or more computers, including hand held devices.

FIG. 40 is the diagram of the System Function of Tools/Help Menu Options Module of the present invention. The architecture of this Module comprises the following functions, which allow a user to select any option for Customization including software maintenance and updating of database.

The Tools/Help Menu Options Module through the User Interface retrieves and brings forth the following options:
Back Up—This utility allows the user to back up the Database(s)
Repair/Restore/Compress—This utility allows the user to repair/restore/compress the Database(s)
Change Sound—This utility allows the user to change the background sounds
System Check—This utility allows the user to initiate a System check
Start Up Options—This utility allows the user to set conditions like Login Screen and Quick Start Screen to appear each time the System is initiated
Customize Header and Footer—This utility allows the user to customize the Header and Footer for the Printed outputs.
Select Skin—This utility allows the user to select the “skins” for the User Interface.
Data Entry Options—This utility allows the user to copy an existing classification and previously entered data for new data input.
Label Printing—This utility allows the user to Print user information labels.
Graphical User Interface Manager—This utility allows the user to change the Labels that appear on the Graphical User Interface.
User Information—This utility allows the user to modify the information entered during registration of the System.
Subject wise WISDOM BYTES Count—This utility allows the user to view WISDOM BYTES stored under particular Subject(s).
Remove Wisdom Bytes Session(s)—This utility allows the user to Delete earlier Wisdom Bytes Session(s), such deletions being capable of being made selectively.
Help—This utility allows the user to invoke the Help files, which provide Help on how best to use the System.

FIG. 41 describes the System Operation of the Tools/Help Menu Options Module explaining that the Module is based on user actions. Through this Module, the user can select any option for customization, including software maintenance and updating of Database.

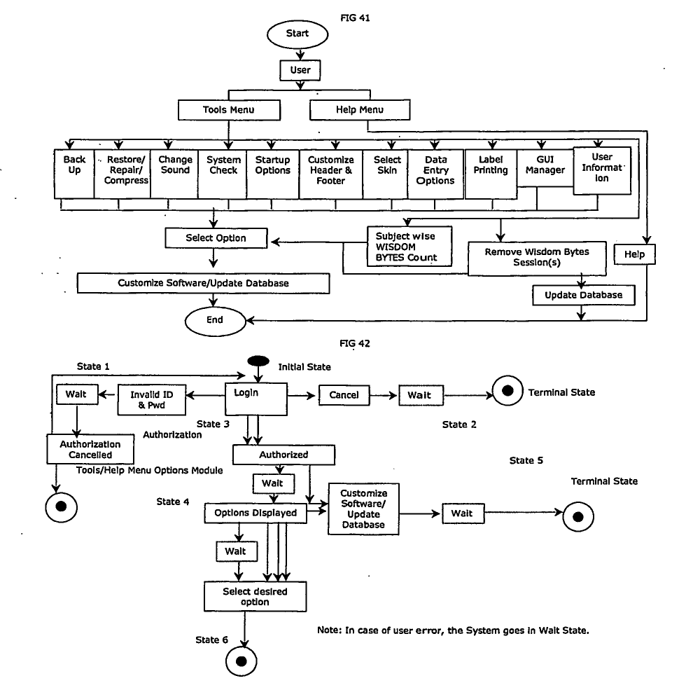

FIG. 42 describes the System State Transition Diagram of the Tools/Help Menu Options Module explaining that the Module is based on different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

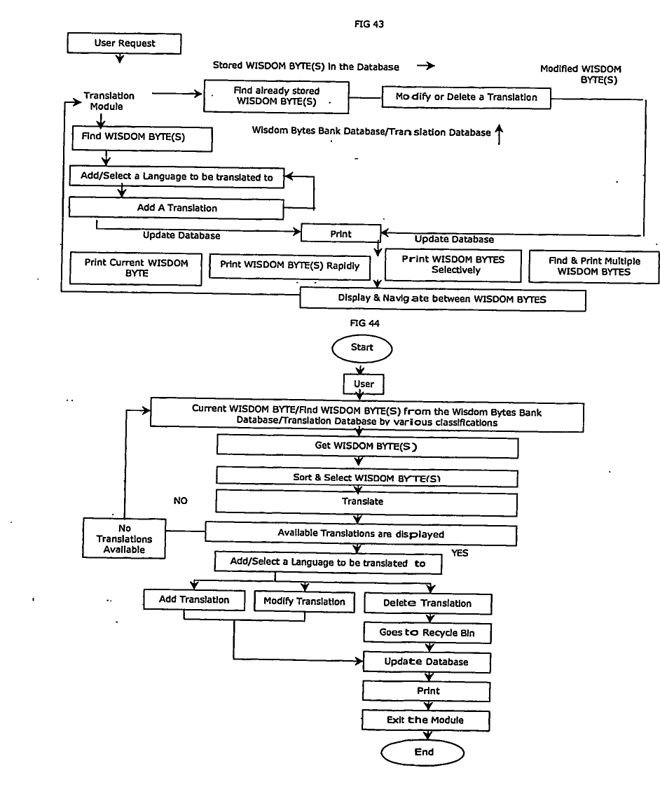

FIGS. 43 to 48 explain the System Function, System Operation and System State Transition respectively, of a Translation utility, allowing the user to consider any Record as a parent language Record and translate the same into one or more languages of the user's choice, the translation activity happening from a Translation Module which is invoked in the Wisdom Bytes Bank Module, and further that all of the features and/or utility(s)/functionality(s) of the System remain common to the translated Record as would be applicable to the parent language Record. There is a further utility of “Global Translation” wherein Record(s) can be found and part(s) of the Record(s) can be translated Globally. The Records can be translated Globally by finding them from the Wisdom Bytes Bank Database/Translation Database, by none or one or more FIND conditions, the Results being displayed to the user in a grid format with a further utility to Sort the Results, Ascending or Descending, by some of the relevant classifications, and further allowing the user to select the Records to be Globally translated from the result grid.—EXAMPLE—The user may want to translate the Subject of some or all WISDOM BYTES having been classified under the Subject GEOGRAPHY from English to Spanish. The Global utility would permit the user to translate this across multiple Records instead of translating the same one by one.

FIG. 43 is the diagram of the System Function of Translation Module of the present invention. The architecture of this Module comprises the following functions, which allow a user to consider any WISDOM BYTE as a parent language Record and Translate the same into one or more languages of the user's choice.

The Translation Module through the User Interface causes the Control System to find and retrieve the relevant data from the Wisdom Bytes Bank Database/Translation Database. The Module allows a user to:
Find existing WISDOM BYTE(S) from the Wisdom Bytes Bank Database/Translation Database by none or one or more FIND conditions
Sort & Select WISDOM BYTE(S)
Select/Add a language
Add Translations
Modify Translations
Delete Translations
Print

FIG. 44 describes the System Operation of Translation Module explaining that the Module is based on user actions, which are performed by loops. The user finds the WISDOM BYTE(S) from the Wisdom Bytes Bank Database/Translation Database, by none or one or more FIND conditions. The user then sorts & selects the WISDOM BYTES and the System then waits for the next user action. Then the user selects a WISDOM BYTE(S) to be translated and translates the same, field by field, through the User Interface. The user can also Modify an earlier translation or Delete the same. The System then waits for the next user action. The user is able to Print the Record from this Module after selecting the appropriate Print criterion. The System then waits for the next user action.

On giving the Close command the System gets notified and the user comes out from the Module.

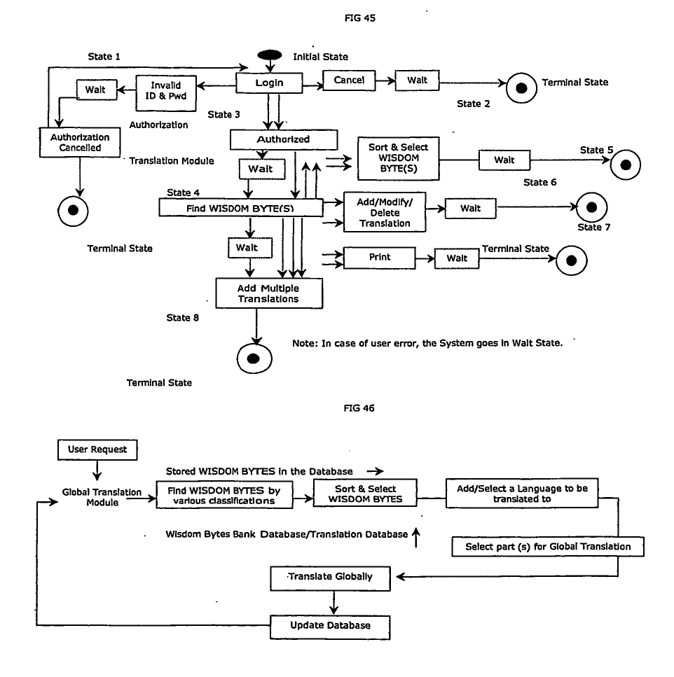

FIG. 45 describes the System State Transition Diagram of the Translation Module explaining that the Module is based on different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

FIG. 46 is the diagram of the System Function of Global Translation Module of the present invention. The architecture of this Module comprises the following functions, which allow a user to translate a selected part of the parent language WISDOM BYTE(S) across several WISDOM BYTES etc. Globally in any language of the user's choice.

The Global Translation Module through the User Interface causes the Control System to find and retrieve the relevant data from the Wisdom Bytes Bank Database/Translation Database by none or one or more FIND conditions. The Module allows a user to:
Find existing WISDOM BYTES by none or one or more FIND conditions
Sort & Select WISDOM BYTES
Select/Add a language
Select part for Global Translation
Translate Globally

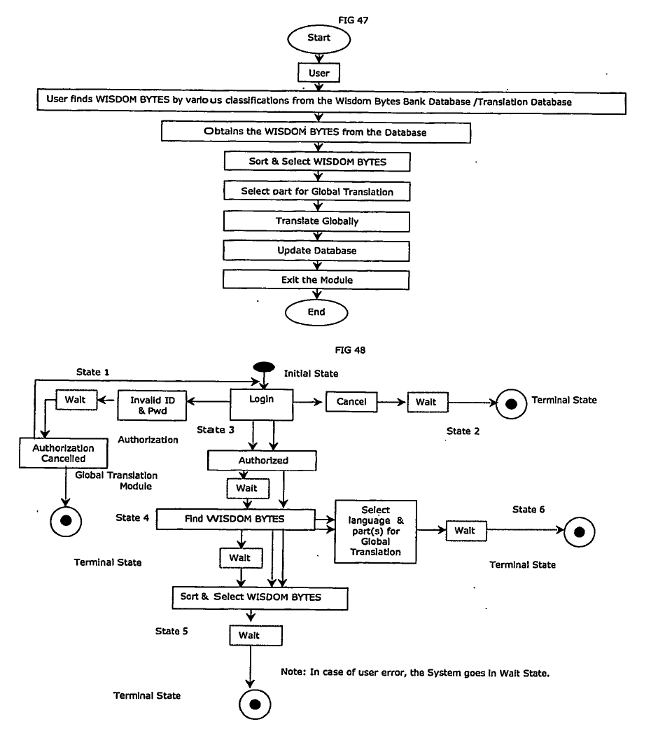

FIG. 47 describes the System Operation of Global Translation Module explaining that the Module is based on user actions.

Once the user finds the WISDOM BYTES from the Wisdom Bytes Bank Database/Translation Database by none or one or more FIND conditions, the user can sort & select the WISDOM BYTES and the System then waits for the next user action. Then the user can select part of the WISDOM BYTES and translate the same across multiple WISDOM BYTES through the User Interface, instead of translating the same one by one. The System then waits for the next user action.

On giving the Close command the System gets notified and the user comes out from the Module.

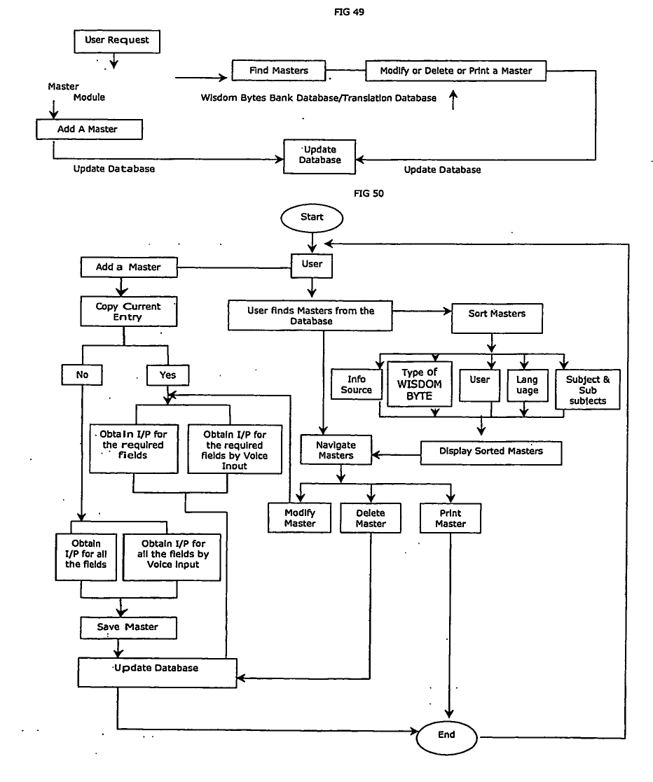

FIG. 48 describes the System State Transition Diagram of the Global Translation Module explaining that the Module is based on different States. The System receives events from the user(s), and each event causes the transition from one state to another within the Module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

FIGS. 49 to 51 explain the System Function, System Operation and System State Transition respectively, of a Master Module which accepts data (such data capable of being accepted from more than one user at the same time), with or without Voice, from the user. The System provides the utility of creating, editing, deleting, printing, navigating, finding Masters like; User, Source of Information, Type, Subject & Sub subjects, Language with sufficient security, so as not to allow the deletion of any Master of a Record that may be in use.

FIG. 49 is the diagram of the System Function of Master Module of the present invention. The architecture of this Module comprises the following functions, which allow a user to create and store Masters with the help of the User Interface.

The Master Module through the User Interface causes the Control System to retrieve the relevant data from the Wisdom Bytes Bank Database/Translation Database. The Module allows a user to:
Find existing Master(s) by none or one or more FIND conditions
Sort & Select Master(s)
Add & Save Master(s)
Modify & Save Master(s)
Delete Master(s)
Copy Current Entry
Print Master(s)
Go To a Master

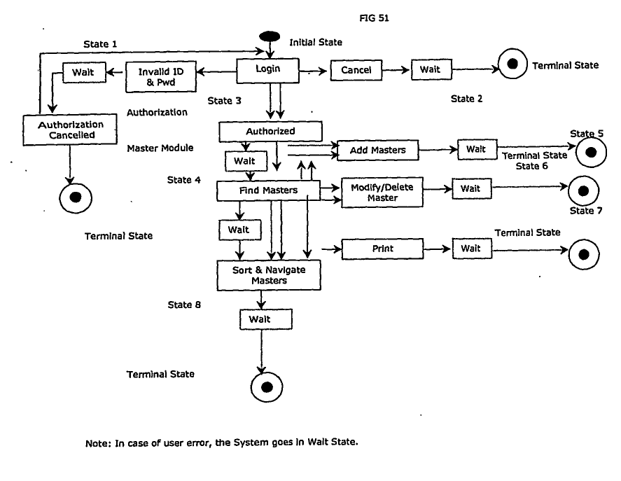

FIG. 50 describes the System Operation of the Master Module explaining that the Module is based on user actions, which are performed by loops.

The Add functionality allows the user to Input data in all the fields. The functionality is controlled through a top-level loop. The Control System updates the Database and the System then waits for the next user action.

The FIND functionality is controlled through a top-level loop wherein the user is asked to enter/select the find criteria, to bring forth Masters based on the FIND criteria. After finding the Masters, the user can sort the Masters by different classifications and can then Modify, Delete or Print the Masters. After Modification, if the user saves the Master, the database gets updated and the System then waits for the next user action. Similarly, after deleting a Master, the database gets updated and the System then waits for the next user action.

The Copy Current Entry functionality is controlled through a top-level loop.

This functionality allows the user to copy the data existing in one or more of the fields of the current Master and make the necessary Additions/Modifications in the other fields. The Control System updates the new Master in the Database and the System then waits for the next user action.

The Printing functionality is controlled through a top-level loop. The user can Print the Masters. The Control System retrieves the Master(s) from the Database and then the System waits for the next user action.

The Navigation functionality allows the user to navigate between Masters.

On giving the Close command the System gets notified and the user comes out from the Module.

FIG. 51 describes the System State Transition Diagram of the Master Module explaining that the Module is based on different States. The System receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own Terminal State. A transition shown with a dotted line indicates that it is leaving from one State and entering another state.

Thus, while there have been shown and described and pointed out fundamental novel features of the present invention as applied to preferred embodiments thereof, it will be understood that the described embodiments are to be considered in all respects only as illustrative and not restrictive and various omissions, substitutions, and changes in the form and details of the methods described may be made by those skilled in the art without departing from the spirit of the present invention. For example, it is expressly intended that all combinations of those elements and/or method steps which perform substantially the same function in substantially the same way to achieve the same results are within the scope of this invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

1-16. (canceled)

17. An interactive system for building, and sharing one's own databank of Wisdom Bytes, such as Words of Wisdom, Basic Truths, and/or Facts and Feats on any subject, in one or more languages, using a computer system comprising:
a) a User Interface;
b) one or more well-classified databases to store data user wise including a Wisdom Byte Bank Database, Translation Database, User Database, and Configuration Database;
c) at least one well classified data input organizing and management module, said data is stored in the form of records in the databases;
d) modules for sharing, invoking, storing, for continuous motivation and for improving one's knowledge of Wisdom Bytes such as Words of Wisdom, Basic Truths, and/or Facts and Feats, using the data from the databank, said data having been selected by a user by finding the same from the databank by none or one or more “FIND” conditions; and
e) a control system acting as a bridge between the User Interface and the databases.

18. The system according to claim 17 wherein the “FIND” conditions are defined by classifications comprising a Date, Record ID, Language, Source of Information, Type of Wisdom Byte, Subject and Sub Subjects, and by keywords, wildcard characters, File Attachments or Bookmark Remarks, including “Favorite”.

19. The system according to claim 17 wherein the modules include a Wisdom Bytes Session Module allowing the user to invoke and store a Wisdom Bytes Session for continuous motivation and for improving one's knowledge of Wisdom Bytes such as Words of Wisdom, Basic Truths, and/or Facts and Feats, using the data from the databank, said data having been selected by the user by finding the same from the databank by none or one or more “FIND” conditions.

20. The system according to claim 17 wherein the modules include a Wisdom Bytes Scheduler Module for allowing the user to schedule the Wisdom Bytes such as Words of Wisdom, Basic Truths, and/or Facts and Feats, by finding the same from the databank by none or one or more “FIND” conditions and said Words of Wisdom, Basic Truths, and/or Facts and Feats are brought up on the user's computer system at preset time intervals.

21. The system according to claim 17 wherein the modules include an Export Module for allowing the user(s) to export data from the databank, said data having been selected by the user(s) by finding the same by none or one or more “FIND” conditions.

22. The system according to claim 17 wherein the modules include an Import Module for allowing the user(s) to import data built by other user(s).

23. The system according to claim 22 wherein the Import Module further includes a utility for selectively importing the data.

24. The system according to claim 17 wherein said data input organizing and management module allows the user to classify the data by well-defined classifications comprising Date, Language, Source of Information, Type of Wisdom Byte, Subject and Sub Subjects.

25. The system according to claim 17 wherein the modules include a Global Attachment Module for allowing the user to attach image, animation, or sound files to a record in the database.

26. The system according to claim 17 wherein the modules include a Global Association Module for allowing the user to associate files, URLs, or remarks to a record in the database.

27. The system according to claim 17 wherein said data input organizing and management module further includes a utility for copying of existing classification and previously entered data for new data input by the user for ease of data entry.

28. The system according to claim 17 wherein the modules include a Global Modification Module for allowing the user to modify a record in the database individually and globally.

29. The system according to claim 17 wherein the modules include a Global Delete Module for allowing the user to delete a record in the database individually and globally.

30. The system according to claim 17 wherein the modules include a Recycle Bin Module for allowing the user to restore or permanently remove a Record individually or plurally from the database.

31. The system according to claim 17 wherein the modules include a report Module for allowing user to print reports and/or graphs from the data in the databank, by none or one or more “FIND” conditions.

32. The system according to claim 17 wherein the modules include a Global Bookmark/Unbookmark Module for allowing the user to bookmark or unbookmark a record in the database, individually or globally with Bookmark Remarks including “Favorite”.

33. The system according to claim 17 wherein the modules include a Translation Module as well as a Global Translation Module for allowing translation of a record in the database, from one language into another of the user's choice, individually or globally.

34. The system according to claim 17 wherein the modules include a Tools/Help Menu Options Module for allowing the user to select an option for customization including system maintenance and updating of the database.

35. The system according to claim 17 wherein the modules include a Master Module for allowing the user to create and store masters for well-defined classifications.

36. The system according to claim 17 wherein the modules and utilities of said modules are adapted to operate within a browser and/or other viewing and/or processing programs and to operate on one or more computer systems including hand held devices.
